(19) United States
(12) Patent Application Publication
(10) Pub. No.: US 2014/0312719 A1
(43) Pub. Date: Oct. 23, 2014

(54) LINEAR GENERATOR

(71) Applicant: GENNEO, INC., LEE'S SUMMIT, MO (US)

(72) Inventor: BLAKE L. ISAACS, LEE'S SUMMIT, MO (US)

(73) Assignee: GENNEO, INC., LEE'S SUMMIT, MO (US)

(21) Appl. No.: 14/258,312

(22) Filed: Apr. 22, 2014

Related U.S. Application Data
(60) Provisional application No. 61/815,004, filed on Apr. 23, 2013.

(51) Int. Cl. H02K 35/02

(52) U.S. Cl. CPC H02K 35/02
USPC 310/30

(57) ABSTRACT

A linear generator having adjacent coils spaced apart no more than approximately 6 millimeters, and a magnet that moves through the coils. The magnet has a height that is greater than a combined height of at least two of the coils. Preferably, a pair of series-connected coils are spaced apart a distance that equals the magnet height. Current induced in the series-connected coils is in phase. The generator may have a second magnet that is oriented to repel the first magnet and that moves at a slower speed than the first magnet. An electric energy storage device is preferably coupled with the coil and a battery charger that receives energy from the storage device when it reaches a charging level. The storage device preferably receives energy from the coil through a rectifier when a voltage level in the coil is greater than a voltage level in the storage device.

### CROSS-REFERENCE TO RELATED APPLICATIONS

This application is based on and claims priority to U.S. Provisional Application Ser. No. 61/815,004, filed on Apr. 23, 2013, which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The present invention is directed to a linear generator, and more particularly, to a portable linear generator with enhanced efficiency.

2. Description of Related Art

A conventional linear generator converts the kinetic energy of a linearly oscillating magnet into electric energy by sending the magnet through magnet wire coils to induce electric current within the coils. A rectifier and storage device may be connected to the coils to capture and store the electric energy generated. While conventional linear generators are effective to convert kinetic energy into electric energy, conventional linear generators are too inefficient to provide meaningful amounts of useable electric energy for charging cellular phones and other battery powered electronics with minimal user effort.

### BRIEF SUMMARY OF THE INVENTION

A linear generator in accordance with one embodiment of the present invention has a plurality of coils each having an opening that is aligned with the opening of the other coils. Adjacent coils are spaced apart no more than approximately 6 millimeters. A magnet moves through the opening of each of the coils. The magnet has a height that is greater than a combined height of at least two of the coils. This configuration increases the efficiency of the generator by substantially preventing competing currents from being induced in the coils.

The coils may include at least one pair of coils with centers that are spaced a distance A. The coils of the pair of coils are connected in series. The magnet preferably has a height that is substantially equal to the distance A. Current induced in one coil of the pair of coils as a result of movement of the magnet is substantially in phase with current induced in the other coil of the pair of coils as a result of movement of the magnet. This configuration increases the efficiency of the generator by placing a coil at each end of the magnet to induce current in each coil that is in phase with current induced in the other coil.

A linear generator in accordance with another embodiment of the present invention has a plurality of coils each having an opening that is aligned with the opening of the other coils. A first magnet moves through the opening of each of the coils. A second magnet moves in a direction that is aligned with the direction of movement of the first magnet. The second magnet is oriented to repel the first magnet, and the second magnet moves at a slower speed than the first magnet. The second magnet is preferably part of a magnet assembly with a mass that is greater than the mass of the first magnet. The magnet assembly is heavier than the first magnet so that it can drive the first magnet at a higher velocity and frequency than the velocity and frequency at which the first magnet would otherwise reciprocate for the purpose of sending the first magnet through the coils at a higher velocity and more often, thereby generating more frequent and higher amplitude voltage pulses within the coils.

A linear generator in accordance with another embodiment of the present invention has a coil with an opening, a magnet that moves through the opening in the coil to induce electric current in the coil, an electric energy storage device electrically coupled with the coil, and a battery charger electrically coupled with the electric energy storage device. The battery charger receives electric energy from the electric energy storage device when the electric energy stored in the electric energy storage device reaches a charging level. The electric energy storage device allows the generator to capture energy more quickly than if the coil was connected directed to the battery charger.

Another embodiment of linear generator in accordance with the present invention has a coil with an opening, a magnet that moves through the opening in the coil to induce electric current in the coil, a rectifier electrically coupled to the coil, and an electric energy storage device electrically coupled with the rectifier. The electric energy storage device receives electric energy from the coil through the rectifier when a level of voltage in the coil is greater than a level of voltage in the electric energy storage device.

A rectifier in accordance with another embodiment of the present invention is operable to be electrically coupled between an electric energy source and an electric energy storage device. The rectifier has a first voltage divider electrically coupled with the electric energy source, a second voltage divider electrically coupled with the electric energy storage device, a comparator with a first input that is electrically coupled with the first voltage divider and a second input that is electrically coupled with the second voltage divider, a first p-channel transistor with a gate that is electrically coupled with an output of the comparator, a source that is electrically coupled with the electric energy source, and a drain, and a second p-channel transistor with a gate that is electrically coupled with the output of the comparator, a source that is electrically coupled with the electric energy storage device, and a drain that is electrically coupled with the drain of the first p-channel transistor.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a linear generator in accordance with one embodiment of the present invention;

FIG. 2 is a cross-sectional side view of the linear generator shown in FIG. 1 taken through the line 2-2 in FIG. 3;

FIG. 3 is a top plan view of the linear generator shown in FIG. 1;

FIGS. 4A-B are a diagram of a rectifier and energy storage circuit of the linear generator shown in FIG. 1;

FIG. 5 is a diagram of a rectifier circuit of the rectifier and energy storage circuit shown in FIGS. 4A-B;

FIG. 6 is a diagram of a shake sensor circuit of the linear generator shown in FIG. 1;

FIG. 7 is a diagram of an alternative embodiment of a shake sensor circuit of the linear generator shown in FIG. 1;

FIG. 8 is a diagram of a battery charging and power supply circuit of the linear generator shown in FIG. 1;

FIG. 9 is a cross-sectional side view of an alternative embodiment of linear generator in accordance with the present invention;

FIG. 10 is a cross-sectional side view of another alternative embodiment of linear generator in accordance with the present invention;

FIG. 11 is a diagram of an alternative embodiment of rectifier circuit for use with a linear generator in accordance with the present invention;

FIG. 12 is an alternative embodiment of magnet for use with a linear generator in accordance with the present invention; and

FIG. 13 is a diagram of an alternative embodiment of battery charging and power supply circuit for use with a linear generator in accordance with the present invention.

### DETAILED DESCRIPTION OF PREFERRED EMBODIMENT

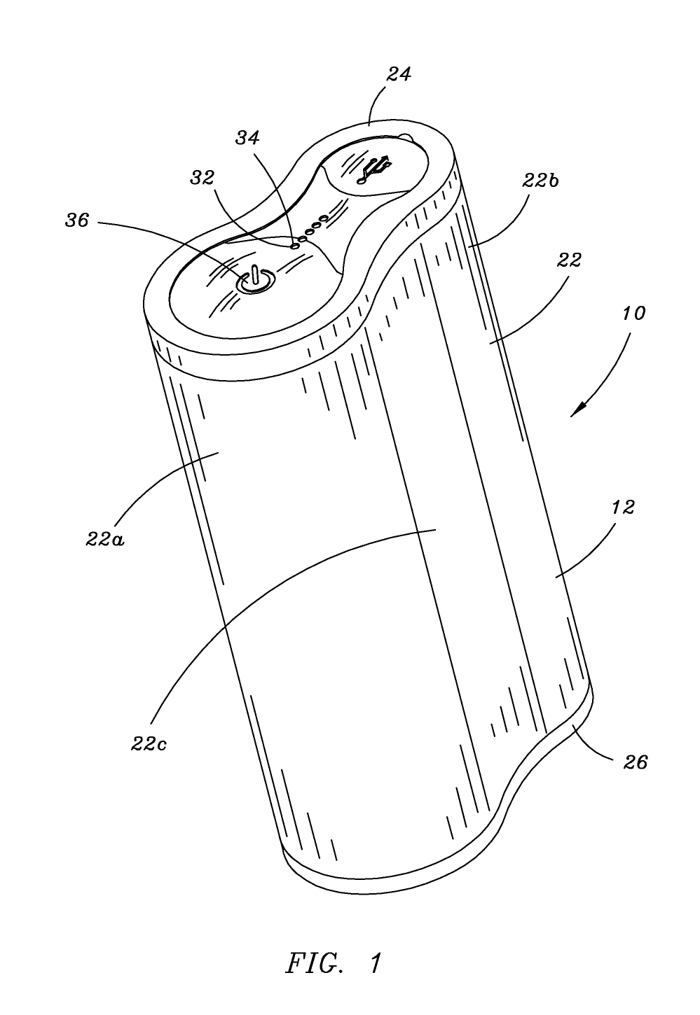

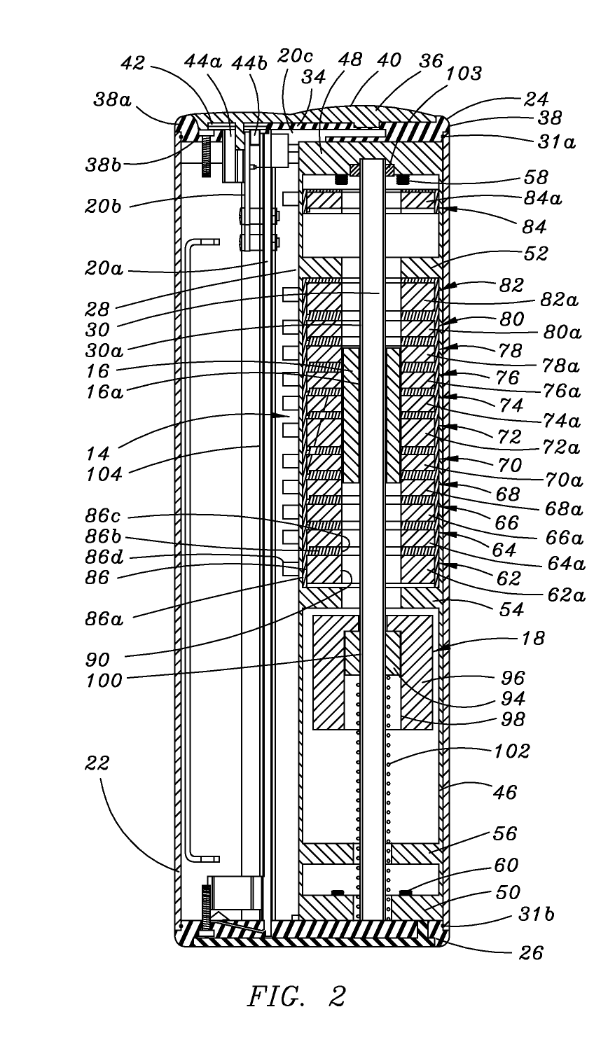

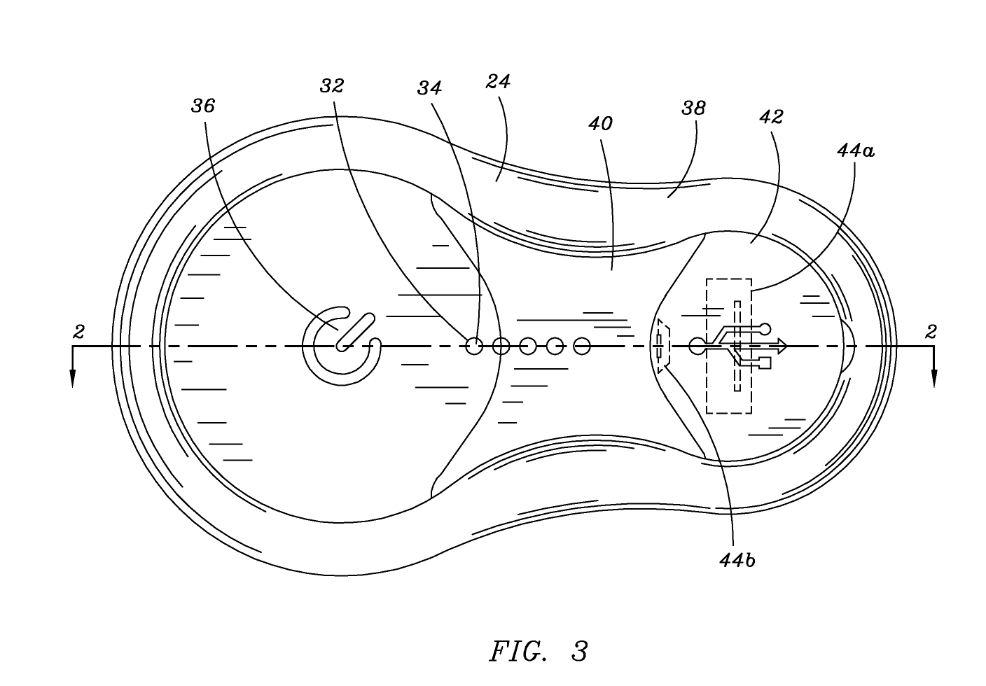

Referring now to FIGS. 1 and 2, a linear generator in accordance with the present invention is shown generally as 10. Linear generator 10 includes a housing 12 that encloses a coil array 14 (FIG. 2), a free magnet 16, magnet assembly 18, and circuit boards 20a-c. The housing 12 includes an elongate outer shell 22, end caps 24 and 26 at the ends of the outer shell 22, a coil array mount 28 joined to end caps 24 and 26, and a rod 30 extending through coil array mount 28.

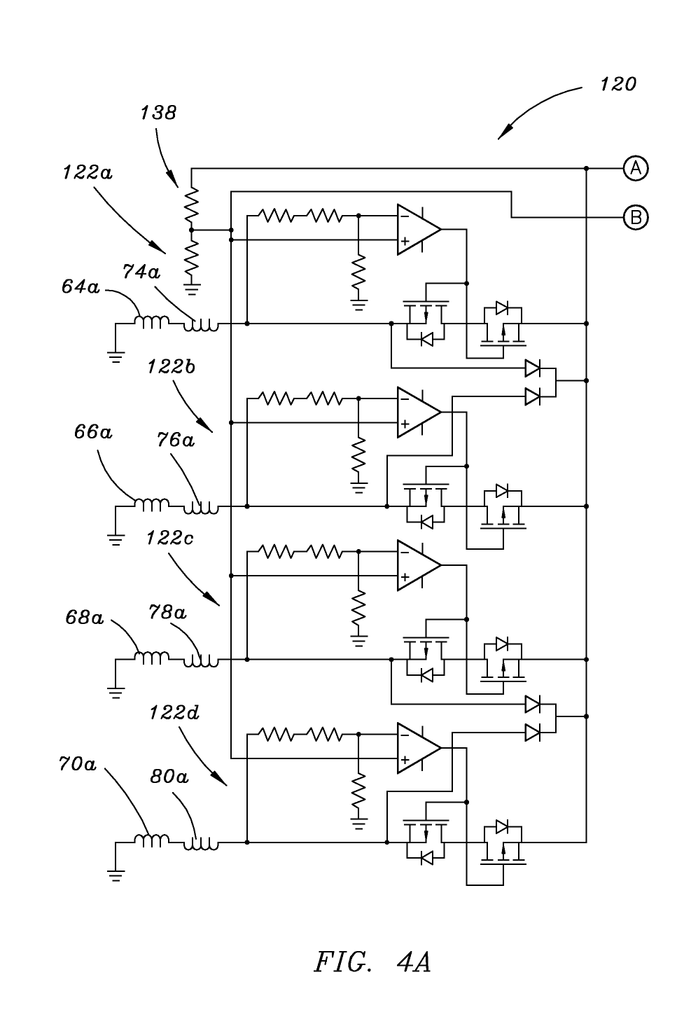

Outer shell 22 includes two half-cylindrical portions 22a and 22b that are joined with opposing concave surfaces, one of which is shown as 22c. The structure of the outer shell 22 is preferably easy for a user's hand to grip with the half-cylindrical portion 22a positioned in the user's palm and the user's fingers extending over the concave surface 22c. The half-cylindrical portions 22a and 22b and concave surfaces 22c in combination are preferably formed from a single, integral piece of extruded aluminum or other suitable non-magnetic material. Alternatively, a user with smaller hands would grip generator 10 so that the portion 22b is positioned in the user's palm. End caps 24 and 26 are positioned at the ends of the outer shell 22 to enclose an interior space within the outer shell 22. Seals 31a and 31b, shown in FIG. 2, are positioned between the outer shell 22 and end caps 24 and 26 to seal the inside of outer shell 22 from contaminants. As best shown in FIG. 3, end cap 24 includes a row of five openings, one of which is identified as 32, through which five LED lights, one of which is identified as 34 may be viewed. End cap 24 also includes a button 36. The end cap 24 includes a frame 38 that receives a sealing portion 40. The sealing portion 40 includes a flap 42 that may be folded back away from the frame 38 to uncover USB ports 44a-b. The openings in end cap 24 for lights 34 are preferably sealed to prevent contaminants from entering the housing 12. Referring to FIG. 2, frame 38 includes an end portion 38a having the same width as outer shell 22, and an inner portion 38b with a width that is less than the width of outer shell 22 such that the inner portion 38b fits within the outer shell 22. End cap 26 has a similar construction and fits within the outer shell 22 in a similar manner.

Referring to FIG. 2, coil array mount 28 includes a cylinder 46 with end plates 48 and 50, and three ring-shaped spacers 52, 54, and 56 positioned between the end plates 48 and 50. Rod 30 extends through the center of cylinder 46 and is mounted to end plates 48 and 50. Screws 58 join end cap 24 to end plate 48, and screws 60 join end cap 26 to end plate 50. Tightening the screws 58 and 60 clamps the outer shell 22 between the end caps 24 and 26 to eliminate gaps between the outer shell 22 and end caps 24 and 26 and tightly seal the housing 12.

Spacers 52 and 54 are positioned to retain between them eleven magnet wire coil assemblies 62, 64, 66, 68, 70, 72, 74, 76, 78, 80, and 82. Spacers 52 and 54 have openings which are sized to allow magnet 16 to pass through them. A twelfth magnet wire coil assembly 84 is positioned at the top of coil array mount 28 adjacent end plate 48. Magnet wire coil assemblies 62, 64, 66, 68, 70, 72, 74, 76, 78, 80, 82, and 84 include magnet wire coils 62a, 64a, 66a, 68a, 70a, 72a, 74a, 76a, 78a, 80a, 82a, and 84a, respectively. Each of the magnet wire coil assemblies 62, 64, 66, 68, 70, 72, 74, 76, 78, 80, 82 and 84 has a similar construction. Accordingly, only the structure of magnet wire coil assembly 62 is described in detail herein. Magnet wire coil assembly 62 includes a housing 86 and coil 62a formed of wound magnet wire positioned within housing 86. The housing 86 includes a cylindrical outer side wall 86a joined with a circular end wall 86b. End wall 86b has an opening 86c therethrough. Two conduits, one of which is shown as 86d, extend from side wall 86a toward circuit board 20a for housing the leads that extend from the ends of coil 62a to circuit board 20a. The coil 62a has an opening 90 that is aligned with the opening 86c and the openings of the remainder of the coils 64a, 66a, 68a, 70a, 72a, 74a, 76a, 78a, 80a, 82a, and 84a. Magnet 16 passes through opening 86c and opening 90. The structure of housing 86 and coil 62a permits the magnet 16 to pass very closely by coil 62a because there is no structure positioned between coil 62a and magnet 16.

The coils 62a, 64a, 66a, 68a, 70a, 72a, 74a, 76a, 78a, 80a and 82a of the eleven magnet wire coil assemblies that are adjacent to each other are preferably spaced apart no more than approximately 6 millimeters, more preferably spaced apart no more than approximately 4 millimeters, and most preferably are spaced apart between approximately 1 to 3 millimeters. For example, coils 62a and coil 64a are preferably spaced apart no more than approximately 6 millimeters, which spacing is caused by end wall 86b of coil assembly 62. The spacing between adjacent coils 62a, 64a, 66a, 68a, 70a, 72a, 74a, 76a, 78a, 80a, and 82a is caused by the end wall of the coil assembly between the coils, such as end wall 86b. It is also within the scope of the invention for adjacent coils, such as coil 62a and coil 64a, to be spaced closely next to each other such that the space between the adjacent coils is zero or near zero.

The coils 64a, 66a, 68a, 70a, 74a, 76a, 78a, 80a, and 84a preferably have between approximately 800 to 1600 turns of between approximately 32 to 36 gauge magnet wire. Most preferably, coils 64a, 66a, 68a, 70a, 74a, 76a, 78a, 80a, and 84a have approximately 1200 turns of 34 gauge magnet wire. The coils 62a, 72a, and 82a preferably have between approximately 500 to 1000 turns of 28 to 32 gauge magnet wire, and most preferably approximately 750 turns of 30 gauge magnet wire. Coils 64a, 66a, 68a, 70a, 74a, 76a, 78a, 80a, and 84a preferably have the same height, which is between approximately 2 to 8 mm, and most preferably approximately 5 mm. Coils 62a, 72a, and 82a have heights of between approximately 6 to 15 mm, and most preferably approximately 10 mm. Each of the coils has an outer diameter of between approximately 32 to 38 mm, and most preferably approximately 37 mm. Each of the coils has a hole therethrough having a diameter of between approximately 19.1 to 23 mm, and most preferably approximately 20 mm.

Rod 30 passes through the centers of the openings of coils 62a, 64a, 66a, 68a, 70a, 72a, 74a, 76a, 78a, 80a, 82a and 84a. The ends of rod 30 are coupled with end plates 48 and 50 to support the rod 30. Rod 30, which is cylindrical, guides the free magnet 16 and prevents the free magnet 16 from moving in any direction that is not generally parallel to a central, longitudinal axis of the generator 10 and rod 30. Rod 30 preferably has a diameter of between approximately 5.8 to 6.3 mm, and most preferably approximately 6.2 mm. Rod 30 may be solid or tubular with a hollow center. Rod 30 preferably has an outer surface 30a that is formed of a low friction material such as PTFE. The outer surface 30a may also be formed of a low friction and diamagnetic material such as pyrocarbon or pyrolytic graphite. The entire rod 30 may be formed of the same material such as PTFE or pyrocarbon, or the rod 30 may have a base made from a first material, which is then coated or covered with a second low friction material such as PTFE or pyrocarbon such that only the outer surface 30a of the rod comprises the low friction material. The outer surface 30a of rod 30 is preferably formed of a diamagnetic material to reduce friction between the moving free magnet 16 and the rod 30. When the rod 30 is oriented so that its central axis is vertical or near vertical, the diamagnetic outer surface 30a repels the free magnet 16 away from the diamagnetic outer surface 30a to substantially keep the free magnet 16 centered along the central axis of the rod 30 and prevent it from touching the diamagnetic outer surface 30a. Preventing the free magnet 16 from touching the diamagnetic outer surface 30a eliminates or reduces friction between the free magnet 16 and diamagnetic outer surface 30a to enhance the efficiency of the generator. When the central axis of the rod 30 is not vertical, the free magnet 16 contacts the outer surface 30a, which guides the free magnet 16 so that it moves in a direction that is parallel to the central axis. Thus, the outer surface 30a of the rod 30 is preferably formed of a low friction material to reduce the frictional force between the outer surface 30a and the moving free magnet 16 in order to enhance the efficiency of the generator 10. Further, because the outer surface 30a is preferably diamagnetic and repels the free magnet 16, the friction between the outer surface 30a is further reduced even when the free magnet 16 contacts the outer surface 30a.

Using a rod 30 to constrain free magnet 16 is advantageous because it allows the coils 62a, 64a, 66a, 68a, 70a, 72a, 74a, 76a, 78a, 80a, 82a and 84a to be positioned close to the path of the moving free magnet 16. Positioning the coils 62a, 64a, 66a, 68a, 70a, 72a, 74a, 76a, 78a, 80a, 82a and 84a closer to the moving free magnet 16 increases the amount of electric current induced in the coils as the magnet 16 moves through them.

Additionally, the use of a rod 30 to constrain a ring-shaped free magnet 16 increases the amount of electric current induced in the coils 62a, 64a, 66a, 68a, 70a, 72a, 74a, 76a, 78a, 80a, 82a and 84a as the magnet 16 moves through the coils because the diamagnetic outer surface 30a on the rod 30 is positioned so that it is not between the moving free magnet 16 and the coils. If the diamagnetic outer surface 30a was positioned between the moving free magnet 16 and the coils 62a, 64a, 66a, 68a, 70a, 72a, 74a, 76a, 78a, 80a, 82a and 84a, the diamagnetic outer surface 30a would attenuate the magnetic field from the free magnet 16 and reduce the amount of electric current induced in the coils.

Free magnet 16 is ring-shaped with a cylindrical outer surface and an opening 16a extending longitudinally through its center which receives rod 30. Free magnet 16 moves along rod 30 through the openings in the coils 62a, 64a, 66a, 68a, 70a, 72a, 74a, 76a, 78a, 80a, 82a and 84a to induce electric current in the coils. Free magnet 16 is preferably a grade N42 or higher nickel plated neodymium magnet. The height of free magnet 16 is preferably greater than a combined height of at least two of the coils 64a, 66a, 68a, 70a, 74a, 76a, 78a, and 80a, and most preferably greater than or approximately equal to a combined height of at least four of the coils of coil assemblies 64a, 66a, 68a, 70a, 74a, 76a, 78a, and 80a. The height of free magnet 16 is preferably equal to the distance between the centers of coils 64a and 74a, which is also equal to the distance between the centers of coils 66a and 76a, the distance between the centers of coils 68a and 78a, and the distance between the centers of coils 70a and 80a. The height of free magnet 16 is preferably between approximately 35 to 41 mm, more preferably between approximately 37 to 39.2 mm, and most preferably is approximately 38.1 mm. Free magnet 16 preferably has a diameter of between approximately 12.7 to 26 mm, and most preferably approximately 19.05 mm. The opening 16a in the center of free magnet 16 preferably has a diameter of between approximately 6.2 to 13 mm, and most preferably approximately 6.35 mm. Free magnet 16 preferably has a mass of between approximately 40 to 200 grams, and most preferably approximately 72.4 grams.

Magnet assembly 18 includes a magnet 94 received by an opening within a housing 96. Housing 96 is cylindrical and includes an opening 98 extending longitudinally through its center. The opening 98 has a smaller diameter on the end of the housing 96 facing coil array 14 than on the end of the housing facing end cap 26. Magnet 94 is received within the opening 98 from the end of the housing 96 facing end cap 26. Magnet 94 is cylindrical and includes an opening 100 extending longitudinally through its center. The openings 98 and 100 of housing 96 and magnet 94 receive rod 30 to guide movement of magnet assembly 18. Magnet 94 has a diameter that is slightly smaller than the portion of opening 98 facing end cap 26 and slightly larger than the portion of opening 98 facing coil array 14. The magnet 94 fits snugly within the opening 98 so that the magnet 94 and housing 96 move as a single unit. A compression spring 102, preferably made from bronze, brass, or another suitable non-ferrous material, extends between the end plate 50 of coil array mount 28 and magnet 94. The poles of magnets 94 and 16 are oriented so that magnet 94 repels magnet 16 to force the magnet 16 and magnet assembly 18 away from each other.

As linear generator 10 moves vertically in a direction that is aligned with rod 30, such as when a person walks with or shakes generator 10, magnet assembly 18 reciprocates along rod 30 between spacers 54 and 56 of coil array mount 28. The spacers 54 and 56 may include elastomeric bumpers to reduce noise when the magnet assembly 18 contacts them. As the generator 10 moves, magnet 16 reciprocates along rod 30 between end plate 48 and magnet assembly 18. Magnet assembly 18 may include an elastomeric bumper on its top to reduce noise when magnet 16 contacts it. Magnet 16 has a diameter that is smaller than the opening within spacer 54 so that magnet 16 may pass through spacer 54. A magnet 103 is received by a recess within end plate 48. Magnet 103 is oriented so that it repels magnet 16. Magnet 103 preferably improves the feel and durability of generator 10 by slowing down magnet 16 before it impacts end plate 48. An elastomeric bumper (not shown) may also be joined to end plate 48 adjacent magnet 103 for reducing noise when magnet 16 contacts end plate 48.

Compression spring 102 biases the magnet assembly 18 to a position approximately between end plate 50 and spacer 54 when the generator 10 is at rest. The spring 102 is compressed approximately half-way between end plate 50 and spacer 54 when the generator 10 is vertical and at rest. FIG. 2 shows magnet assembly 18 near the top of its range of motion. The repelling magnetic force between magnets 16 and 94 biases magnet 16 to approximately a position in which the magnet 16 extends from the top of coil assembly 66 to the top of coil assembly 76, when the generator 10 is at rest. As magnet assembly 18 moves downward, spring 102 compresses and stores energy, which is released as magnet assembly 18 moves upward.

Magnet assembly 18 has a mass that is between approximately 0.5 to 4 times, or 2 to 4 times, greater than the mass of free magnet 16. Most preferably, the mass of magnet assembly 18 is approximately 3 times greater than the mass of free magnet 16. Magnet assembly 18 has a mass of between approximately 80 to 600 grams, and most preferably approximately 212.5 grams. The mass of housing 96 is preferably a large portion of the total mass of magnet assembly 18. Because the magnet assembly 18 has a mass that is greater than the free magnet 16, magnet assembly 18 moves at a slower speed than the free magnet 16. The masses of and mass ratio between the free magnet 16 and magnet assembly 18 are preferably chosen so that when generator 10 is carried vertically (i.e., with rod 30 vertical) by a human adult walking at a typical frequency, magnet assembly 18 reciprocates between spacers 54 and 56 at a frequency of between approximately 1.5 to 2.5 Hertz, which equals the typical walking frequency of an adult human, and first magnet 16 reciprocates between end plate 48 and magnet assembly 18 at a frequency of between approximately 2 to 15 Hertz. Magnet assembly 18 is heavier than the free magnet 16 so that it can drive the free magnet 16 at a higher velocity and higher frequency than the frequency at which the free magnet 16 would otherwise reciprocate for the purpose of sending the free magnet 16 through the coils 62a, 64a, 66a, 68a, 70a, 72a, 74a, 76a, 78a, 80a, 82a, and 84a at a higher velocity and more often, thereby generating more frequent and higher amplitude voltage pulses within the coils. Free magnet 16 typically oscillates at a higher frequency than magnet assembly 18 and moves at a higher velocity than magnet assembly 18 when a user shakes generator 10. When a user carries generator 10 as he/she is walking, free magnet 16 typically moves at a higher velocity than magnet assembly 18 due to the mass difference between free magnet 16 and magnet assembly 18, but free magnet 16 may oscillate at substantially the same frequency as magnet assembly 18.

It is also within the scope of the present invention for magnet assembly 18 to be entirely formed of a magnet with an opening received by rod 30. Forming magnet assembly 18 entirely of a magnet would be more expensive than forming magnet assembly 18 of a magnet 94 and housing 96 as described above, but it would allow generator 10 to be shorter because the magnet assembly 18 would have a stronger magnetic field for a given height of the magnet assembly 18. Thus, a magnet assembly 18 formed entirely of a magnet could be shorter than a magnet assembly 18 as described above and still repel the free magnet 16 to the same equilibrium position.

Circuit board 20a is positioned within outer shell 22 and extends approximately the length of the outer shell 22. Circuit board 20a is received by grooves, one of which is shown as 104, formed on an inner surface of outer shell 22. The circuit board 20a may, however, be mounted in any suitable manner within the generator 10. Each of the coils 62a, 64a, 66a, 68a, 70a, 72a, 74a, 76a, 78a, 80a, 82a, and 84a has two leads electrically coupled to circuit board 20a. Circuit board 20b is mounted to and electrically coupled with circuit board 20a. USB ports 44a and 44b are electrically coupled to circuit board 20b. Circuit board 20c is electrically coupled with circuit board 20a, lights 34 and button 36.

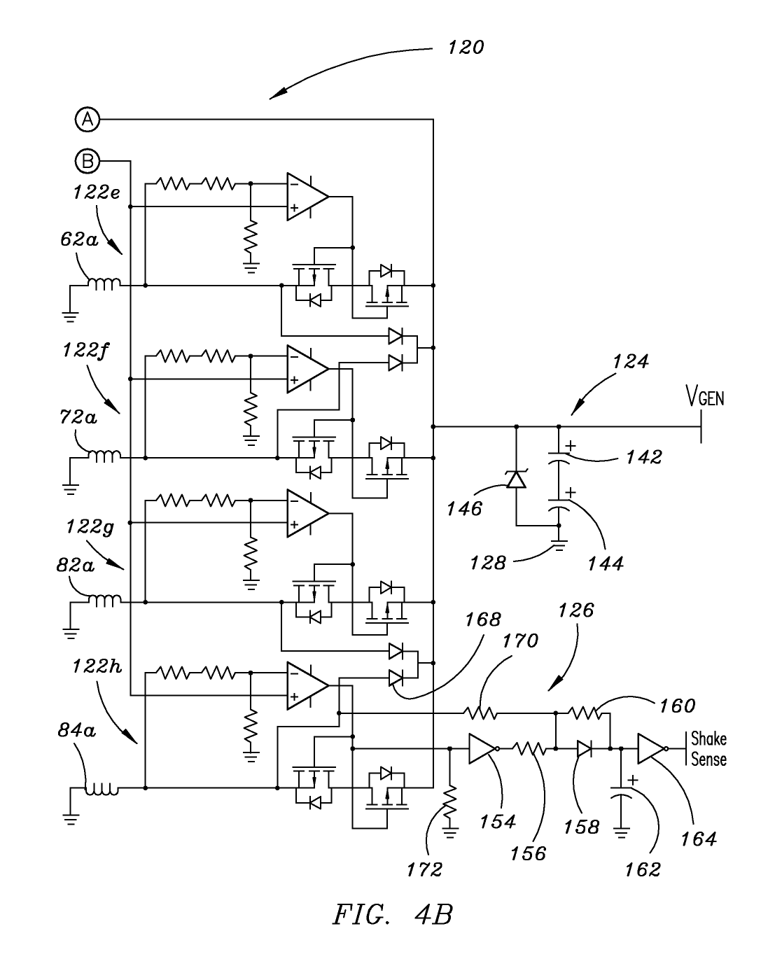

Circuit board 20a includes the rectifier and energy storage circuit generally identified as 120 in FIGS. 4A-B. Rectifier and energy storage circuit 120 is designed to rectify and store the electric energy induced in coils 62a, 64a, 66a, 68a, 70a, 72a, 74a, 76a, 78a, 80a, 82a, and 84a as free magnet 16 (FIG. 2) moves through them. Rectifier and energy storage circuit 120 includes eight rectifier circuits 122a-h that are connected in parallel to an electric energy storage circuit 124. A shake sensor circuit 126 is connected to rectifier circuit 122h. Rectifier circuit 122a includes coils 64a and 74a, which are connected in series. Rectifier circuit 122b includes coils 66a and 76a, which are connected in series. Rectifier circuit 122c includes coils 68a and 78a, which are connected in series. Rectifier circuit 122d includes coils 70a and 80a, which are connected in series. Rectifier circuits 122e-122h includes coils 62a, 72a, 82a, and 84a, respectively.

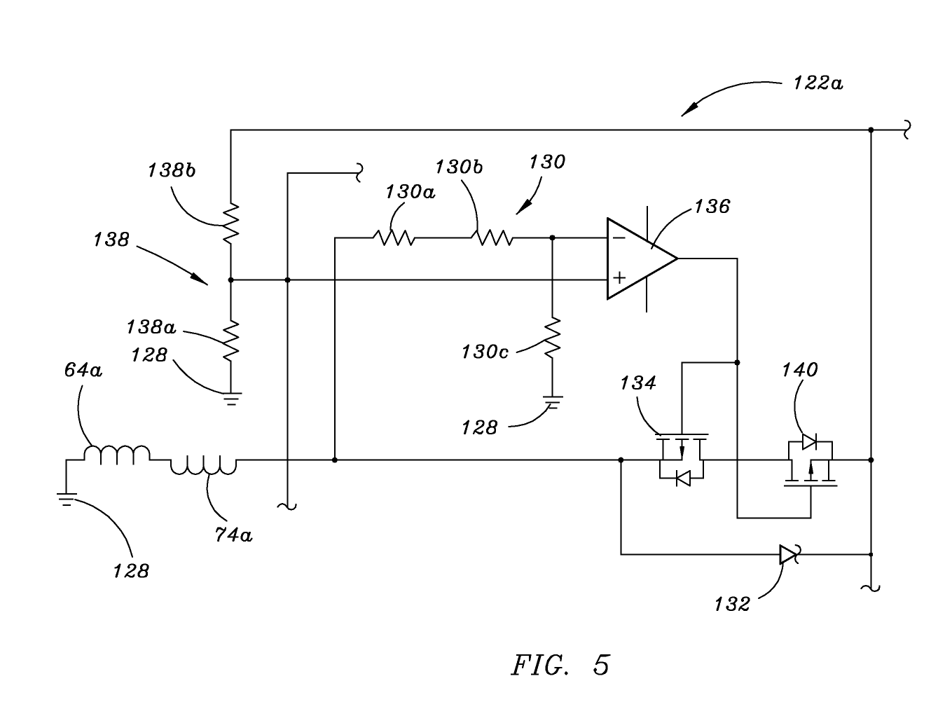

Each of rectifier circuits 122a-h is substantially similar, except that rectifier circuits 122a-d have two coils. Thus, only rectifier circuit 122a, as shown in FIG. 5, is described in detail herein. Rectifier circuit 122a includes coil 64a, one end of which is connected to ground 128 and the other end of which is connected to one end of coil 74a. The other end of coil 74a is connected to a first voltage divider 130, a diode 132, and the source of a first p-channel transistor 134. The first voltage divider 130 includes three resistors 130a-c. One end of resistor 130a is connected to coil 74a and the other end is connected to resistor 130b. One end of resistor 130b is connected to resistor 130a and the other end is connected to resistor 130c and the inverting input of a comparator 136. One end of resistor 130c is connected to resistor 130b and the other end is connected to ground 128. The voltage output by first voltage divider 130 to the inverting input of comparator 136 is preferably the voltage across coils 64a and 74a divided by 3.42. Resistor 130a preferably has a resistance of 20K ohms, resistor 130b preferably has a resistance of 2.4 megaohms, and resistor 130c preferably has a resistance of 1 megaohm.

The non-inverting input of comparator 136 is connected to a second voltage divider 138. Second voltage divider 138 includes a first resistor 138a having one end connected to ground 128 and the other end connected to comparator 136 and a second resistor 138b. Second resistor 138b has one end connected to first resistor 138a and another end connected to electric energy storage circuit 124 (FIG. 4B). The voltage output by second voltage divider 138 to the non-inverting input of comparator 136 is preferably the voltage of electric energy storage circuit 124 divided by 3.4. First resistor 138a preferably has a resistance of 1 megaohm, and second resistor 138b preferably has a resistance of 2.4 megaohms. As shown in FIGS. 4A-B, second voltage divider 138 is also connected to the non-inverting inputs of the comparators of rectifier circuits 122b-122h.

The output of comparator 136 is connected to the gates of first p-channel transistor 134 and a second p-channel transistor 140. The drains of first and second p-channel transistors 134 and 140 are connected. The source of second p-channel transistor 140 is connected to electric energy storage circuit 124 (FIG. 4B). The anode of diode 132 is connected to coil 74a, and the cathode of diode 132 is connected to electric energy storage circuit 124.

Rectifier circuit 122a is designed to connect the coils 64a and 74a with the electric energy storage circuit 124 only when the voltage across the coils 64a and 74a is greater than the voltage of the electric energy storage circuit 124 so that electric energy induced and stored within coils 64a and 74a charges electric energy storage circuit 124, and so that electric energy storage circuit 124 cannot discharge into coils 64a and 74a. Rectifier circuit 122a functions as a micro power tuned synchronous active half-wave rectifier, as discussed in more detail below.

Electric energy is induced within coils 64a and 74a as magnet 16 (FIG. 2) moves through the coils. Because the centers of coils 64a and 74a are spaced apart the height of magnet 16, as discussed above, as magnet 16 moves downward from the position shown in FIG. 2 and one end of the magnet 16 approaches coil 64a, the opposite end of the magnet 16 approaches coil 74a. Thus, magnet 16 simultaneously induces current in both of coils 64a and 74a. The coils 64a and 74a are wound and connected in series such that current induced in coil 64a by magnet 16 is substantially in phase with current induced in coil 74a by magnet 16. In order to ensure that the current simultaneously induced in coils 64a and 74a is in phase, the coils 64a and 74a may be wound in opposite directions and connected in series, as shown in FIG. 5, or the coils 64a and 74a may be wound in the same direction and the connections of the ends of either of coils 64a or 74a may be reversed from what is shown in FIG. 5 (i.e., the end of coil 64a that is connected to ground 128 may be connected to coil 74a and the end of coil 64a that is connected to coil 74a may be connected to ground 128). Because the current simultaneously induced in coils 64a and 74a is in phase and the coils 64a and 74a are connected in series, the voltage generated across each of the coils 64a and 74a adds together to create nearly twice the voltage than would be the case if only one of coils 64a and 74a was present.

Comparator 136 compares the voltage across coils 64a and 74a (Vcoil1) divided by 3.42 (Vcoil1/3.42) with the voltage of electric energy storage circuit 124 (Vgen) divided by 3.4 (Vgen/3.4). First and second voltage dividers 130 and 138 ensure that the voltages input to the comparator 136 do not exceed the power supply voltage of the comparator 136 in order to protect the comparator 136. When Vcoil1/3.42 exceeds Vgen/3.4, the output of comparator 136 switches to low or near zero volts. Because Vcoil1 is divided by 3.42 at the inverting input of comparator 136 and Vgen is divided by a lower value, 3.4, at the non-inverting input of comparator 136, Vcoil1 must be approximately 0.6% higher than Vgen plus the internal hysteresis voltage of comparator 136 (approximately 3.5 mV for the preferred comparator used in generator 10) before the output of comparator 136 switches to low. The low output of comparator 136 is sent to the gates of p-channel transistors 134 and 140, which turns on the transistors 134 and 140 to connect the source and drain of each transistor 134 and 140. When the source and drain of each transistor 134 and 140 are connected, the coils 64a and 74a are connected to electric energy storage device 124 (FIG. 4B). Because the transistors 134 and 140 only connect coils 64a and 74a to electric energy storage device 124 when Vcoil1 exceeds Vgen by at least 1%, the electric energy stored on coils 64a and 74a charges electric energy storage device 124 when coils 64a and 74a are connected to electric energy storage device 124.

As the electric energy on coils 64a and 74a charges electric energy storage device 124, Vgen rises and Vcoil1 lowers. When Vcoil1/3.42 lowers below Vgen/3.4 minus the internal hysteresis voltage of comparator 136 (approximately 3.5 mV), comparator 136 sets its output to high, which turns p-channel transistors 134 and 140 off. When p-channel transistors 134 and 140 are turned off, coils 64a and 74a are disconnected from electric energy storage device 124. Coils 64a and 74a are disconnected from electric energy storage device 124 when Vcoil1 is lower than Vgen to prevent the electric energy stored in electric energy storage device 124 from discharging back through the coils 64a and 74a to ground 128. The p-channel transistors 134 and 140 remain off until Vcoil1 becomes approximately 0.6% higher than Vgen, as described above. The p-channel transistors 134 and 140 function as a switch, which is turned on and off by comparator 136 depending on the difference between Vcoil1/3.42 and Vgen/3.4. There are two transistors 134 and 140 with their drains connected in order to prevent leakage from the body diodes of the transistors 134 and 140 (i.e., transistor 140 prevents discharge of electric energy storage device 124 through transistor 134 when Vgen exceeds Vcoil1).

When the output of comparator 136 is low, the source and drain of each p-channel transistor 134 and 140 are connected so long as the difference between the voltage at the source of the transistors 134 and 140 (i.e., Vcoil1 for transistor 134 and Vgen for transistor 140) and the voltage at the gate of the transistors 134 and 140 (i.e., near zero when comparator 136 is low) is greater than a certain predetermined value based on the design of the transistors (Vgs), which is typically between 0.5-1.0V. Because the gate of transistors 134 and 140 is near zero when they are turned on and Vcoil1 exceeds Vgen, the sources and drains of the transistors 134 and 140 are connected when Vgen exceeds the Vgs of the transistors 134 and 140. Preferably, p-channel transistors 134 and 140 are Vishay Siliconix Si2305CDS transistors.

During normal operation of the generator 10, Vgen will exceed 1V, and is typically in the range of 4.5-5V. However, when the generator 10 is first put into operation, Vgen will likely be less than 1V and Vgs of transistors 134 and 140, the on-threshold voltage of these transistors. Diode 132 is provided to allow electric energy stored on coils 64a and 74a to charge electric energy storage device 124 when Vgen is less than Vgs while also preventing current from flowing from storage circuit 124 back into coils 64a and 74a. The diode 132 is connected in parallel to transistors 134 and 140. Diode 132 preferably has a very low reverse leakage current (e.g., less than 1 microamp at 5V) in order to substantially prevent discharge of electric energy storage device 124 through diode 132 and coils 64a and 74a to ground 128. When Vgen exceeds Vgs, transistors 134 and 140 become operational and can be turned on to allow current to flow from coils 64a and 74a to electric energy storage device 124 as described above. When this occurs, current will preferably no longer flow through diode 132 because Vcoil1/3.42 will exceed Vgen/3.4, thereby turning on transistors 134 and 140, before Vcoil1 exceeds the forward voltage drop of diode 132.

In an alternative embodiment, rectifier circuit 122a may only include diode 132 and not include voltage dividers 130 and 138, comparator 136, and transistors 134 and 140. In such an embodiment, electric energy from coils 64a and 74a charges electric energy storage device 124 when the voltage across coils 64a and 74a, Vcoil1, exceeds the voltage of electric energy storage device 124, Vgen, minus the forward voltage drop of diode 132. Diode 132 substantially prevents discharge of electric energy storage device 124 through coils 64a and 74a to ground 128 when Vgen exceeds Vcoil1.

While a half-wave rectifier diode only circuit would be effective as a substitute for rectifier circuit 122a, the diode only circuit is less efficient than the rectifier circuit 122a shown in FIG. 5 because the forward voltage drop of diode 132 must be overcome before energy from coils 64a and 74a can charge electric energy storage device 124. In testing the half-wave rectifier circuit shown in FIG. 5 with an LM339 comparator and a pair of Fairchild QPF27P06 p-channel transistors against a half-wave rectifier circuit consisting only of a 1N5817 Schottky diode, the rectifier circuit 122a shown in FIG. 5 captured 3-5% more energy than the diode-only circuit and was 2-4% more efficient in converting kinetic energy to electric energy. The rectifier circuit 122a shown in FIG. 5 is preferable over a diode only half-wave rectifier circuit for the additional reason that if a low-voltage Schottky diode is used in a diode only rectifier, the reverse leakage of the diode is relatively high (e.g., 0.5 mA at 5V), while the reverse leakage of the transistors 134 and 140 is near zero.

In another alternative embodiment, the diode 132 and transistor 140 may be omitted from rectifier circuit 122a. By eliminating transistor 140, diode 132 would no longer be needed because operation of transistor 134 is not dependent on Vgen.

Referring to FIG. 4B, electric energy storage circuit 124 includes first and second series connected capacitors 142 and 144 which are connected in parallel with a Zener diode 146 that has a breakdown voltage of approximately 5.3V. One end of capacitor 142 is connected to the output of each of the rectifier circuits 122a-h. The voltage at this end of capacitor 142 represents Vgen, described above. The other end of capacitor 142 is connected to capacitor 144. The opposite end of capacitor 144 is connected to ground 128 and the cathode of diode 146. The anode of diode 146 is connected to the end of capacitor 142 at the voltage Vgen. The Zener diode 146 protects the capacitors 142 and 144 by ensuring that if the voltage across the capacitors exceeds 5.3V, energy stored in the capacitors 142 and 144 can discharge through the Zener diode 146 to ground 128. Preferably, capacitors 142 and 144 are substantially similar with equal capacitances and are capable of storing energy at a voltage that is greater than half of the breakdown voltage of the Zener diode 146. Capacitors 142 and 144 store the electric energy generated by coils 62a, 64a, 66a, 68a, 70a, 72a, 74a, 76a, 78a, 80a, 82a, and 84a. Capacitors 142 and 144 are preferably Maxwell Technologies BCAP0001 supercapacitors each having a capacitance of approximately 1 Farad and a reverse leakage of less than 6 microamps. Although capacitors 142 and 144 are most preferably used in electric energy storage circuit 124, it is within the scope of the invention for any suitable type of electric energy storage device to be used in lieu of capacitors 142 and 144.

As described in more detail below, capacitors 142 and 144 are connected to a battery charger, which utilizes electric energy from capacitors 142 and 144 to charge a battery at a current level that is no greater than a maximum electric current level as recommended by the manufacturer of the battery. The battery charger preferably charges at a current level that is less than the maximum electric current level. Capacitors 142 and 144 form an energy buffer between the rectifier circuits 122a-h and the battery charger that is preferably capable of storing electric energy from an electric current that is greater than the maximum electric current level that battery charger may utilize to charge battery. Thus, capacitors 142 and 144 allow generator 10 to accumulate and store energy generated by coils 62a, 64a, 66a, 68a, 70a, 72a, 74a, 76a, 78a, 80a, 82a, and 84a more quickly than would be the case if the coils were directly connected to the battery charger.

As shown in FIG. 2, the height of free magnet 16 spans at least five coils 68a, 70a, 72a, 74a, and 76a. It is advantageous for the heights of coils 62a, 64a, 66a, 68a, 70a, 72a, 74a, 76a, 78a, 80a, 82a, and 84a to be sized such that the height of magnet 16 spans multiple coils in order to increase the efficiency of generator 10. If, for example, coils 68a, 70a, 72a, 74a, and 76a were combined into one large coil, competing currents would be induced within the large coil as the magnet 16 moves through it. With one large coil, as one end of the magnet enters the coil, it induces current in one direction in turns of the coil ahead of the magnet end, and it induces competing current in the opposite direction in turns of the coil from which the magnet end is receding. These competing currents cancel each other out, reducing the overall amount of electric energy generated by the coil and significantly reducing efficiency. By slicing a larger coil into multiple coils, such as coils 62a, 64a, 66a, 68a, 70a, 72a, 74a, 76a, 78a, 80a, 82a, and 84a, with heights sized so that the height of the free magnet 16 spans multiple coils, the efficiency of the generator 10 is improved. Referring to FIG. 2, as the top end of magnet 16 moves upward toward coils 78a, 80a, and 82a and away from coil 76a, current is induced in one direction in coil 76a and in an opposite direction in coils 78a, 80a, and 82a. Because the coils 76a, 78a, 80a, and 82a are connected to separate rectifier circuits 122b, 122c, 122d, and 122g (FIGS. 4A-B), respectively, the opposite direction current induced in coil 76a does not compete and cancel out the current induced in any of the coils 78a, 80a, and 82a as would be the case if the coils 76a, 78a, 80a, and 82a were replaced with one large coil having the same number of turns.

In order to test splitting a large coil into multiple coils, a single coil of 2000 turns was tested against a four coil array with each coil having 500 turns. The single coil and each coil of the coil array had substantially the same inner and outer diameters. The height of the single coil was substantially the same as the combined height of the coils of the coil array. The coils of the coil array were spaced apart by approximately 2.35 mm. The mean radius of the single coil and coil array was 2.2 cm, and the height of the single coil and coil array was 0.425 cm. The single coil and coils of the coil array were wound with 32 gauge magnet wire. The coils were tested by dropping a single magnet through the coils. The magnet had an outer diameter of 0.75″, an inner diameter of 0.5″, and a length of 1.5″, and was formed from four of K&J Magnetics part number RC86 connected end-to-end and held in place relative to each other by their attracting magnetic fields. The single coil and coil array were tested separately by placing a guide tube through their inner openings. The magnet was placed over the guide tube so that the opening of the magnet received the guide tube. The magnet was dropped through the coil and coil array from three different heights, 0 mm, 100 mm, and 200 mm as measured from the bottom of the magnet to the top of the coil or coil array, and energy captured by the coils was measured as described below. Two magnetic switches were placed in parallel, one at the bottom of the coil or coil array, and the other approximately 95 mm below the first for the purpose of determining the velocity of the magnet as it exited the coil or coil array.

Half-wave rectifier circuits were used to capture the energy induced within the coils as follows. One end of the single coil was connected to the cathode of a first diode (the anode of the first diode was grounded), and the other end was connected to the anode of a second diode. The cathode of the second diode was connected to one end of a capacitor, the other end of which was grounded. Each of the coils of the four coil array was connected to the cathode of a first diode, and the other end was connected to the anode of a second diode. The coil, first diode, and second diode were connected in parallel such that the anode of each first diode was grounded, and the cathode of each second diode was connected to one end of a capacitor, the other end of which was grounded. The capacitor used in each case was a 1000 microfarad aluminum polymer capacitor.

The test results are as set forth in the table below. Capacitor voltage was measured with an oscilloscope and precision volt-meter. The capacitor energy refers to the amount of energy captured in the capacitor as determined based on the voltage and capacitance of the capacitor. Kinetic energy lost refers to the amount of kinetic energy that the magnet lost as it moved through the coil or coil array. This number is determined based on the velocity of the magnet as it exits the coil or coil array, which is determined based on the time it takes the magnet to travel between the two magnetic switches. The kinetic to electrical conversion efficiency is simply the capacitor energy divided by the kinetic energy lost. Friction between the magnet and guide rod was negligible based on testing.

| | | | | Kinetic to |
|---|---|---|---|---|
| | | | Kinetic | Electrical |
| | Capacitor | Capacitor | Energy | Conversion |
| | Voltage | Energy | Lost | Efficiency |
| Height/Coil Type | (V) | (mJ) | (mJ) | (%) |
| 0 mm drop height, | 1.91 | 1.81 | 12.92 | 14.0 |
| single coil | | | | |
| 0 mm drop height, | 2.03 | 2.07 | 9.07 | 22.8 |
| coil array | | | | |
| 100 mm drop height, | 2.44 | 2.97 | 22.75 | 13.1 |
| single coil | | | | |
| 100 mm drop height, | 3.1 | 4.81 | 21.3 | 22.6 |
| coil array | | | | |
| 200 mm drop height, | 2.65 | 3.5 | 44.13 | 7.9 |
| single coil | | | | |
| 200 mm drop height, | 4.14 | 8.58 | 44.13 | 19.5 |
| coil array | | | | |

Thus, the test results above indicate that splitting a single coil into multiple coils enhances the efficiency of a linear generator by converting more of the kinetic energy of a moving magnet into electrical energy. The kinetic to electrical conversion efficiency for the coil array at all heights was approximately 20-23%, while the kinetic to electrical conversion efficiency for the single coil was significantly less at around 8-14%.

The combination of pairs of in-phase series connected coils with centers that are separated by the height of the free magnet 16, i.e., coil pair 64a and 74a, coil pair 66a and 76a, coil pair 68a and 78a, and coil pair 70a and 80a, and coils 62a, 64a, 66a, 68a, 70a, 72a, 74a, 76a, 78a, 80a, 82a, and 84a with heights sized such that the height of free magnet 16 spans multiple coils improves the efficiency of generator 10 by placing twice as many coil turns within the strongest part of the magnetic field of magnet 16 (i.e., near the ends of magnet 16) and ensuring that energy captured by those coils is accretive. For example, as one end of magnet 16 moves upward through coil 74a and the other end of magnet 16 moves through coil 64a, the coils 64a and 74a are positioned such that electric current is simultaneously induced within the coils 64a and 74a from the strongest part of the magnetic field of magnet 16, which is near the ends of the magnet 16. The electric energy generated within the coils 64a and 74a is added together by rectifier circuit 122a in the manner described above, and charges electric energy storage circuit 124 if Vcoil1/3.42 is greater than Vgen/3.4, as described above. Then, just as the pulse of electric energy generated in coils 64a and 74a subsides due to magnet 16 moving upward away from those coils, the ends of magnet 16 approach coils 66a and 76a to induce electric current within those coils that charges electric energy storage circuit 124. This process repeats as magnet 16 approaches coils 68a and 78a and coils 70a and 80a. As the magnet 16 moves successively through the coil pairs 64a and 74a, 66a and 76a, 68a and 78a, and 70a and 80a, each of the coil pairs successively generates a pulse of electric energy that charges electric energy storage circuit 124 such that electric energy is almost continuously being generated for charging electric energy storage circuit 124 as magnet 16 moves.

Each of coils 62a, 72a, and 82a has a height which is slightly greater than the remainder of the coils and more turns than the other coils. Each of coils 62a, 72a, and 82a has its own rectifier circuit, 122e, 122f, and 122g, respectively, and is not connected to another one of the coils. The coils 62a, 72a, and 82a are designed to capture relatively large amounts of electric energy when a person shakes generator 10 to rapidly move magnet 16 through the coils 62a, 72a, and 82a.

Coils 62a, 64a, 66a, 68a, 70a, 72a, and 82a preferably have windings that are wound to the right, and coils 74a, 76a, 78a, 80a, and 84a preferably have windings that are wound to the left. It is within the scope of the invention for there to be more than four pairs of series connected coils, wherein the centers of the coils in each pair are separated by the height of the free magnet 16. For example, the invention may include one pair of series connected coils or fifty pairs of series connected coils.

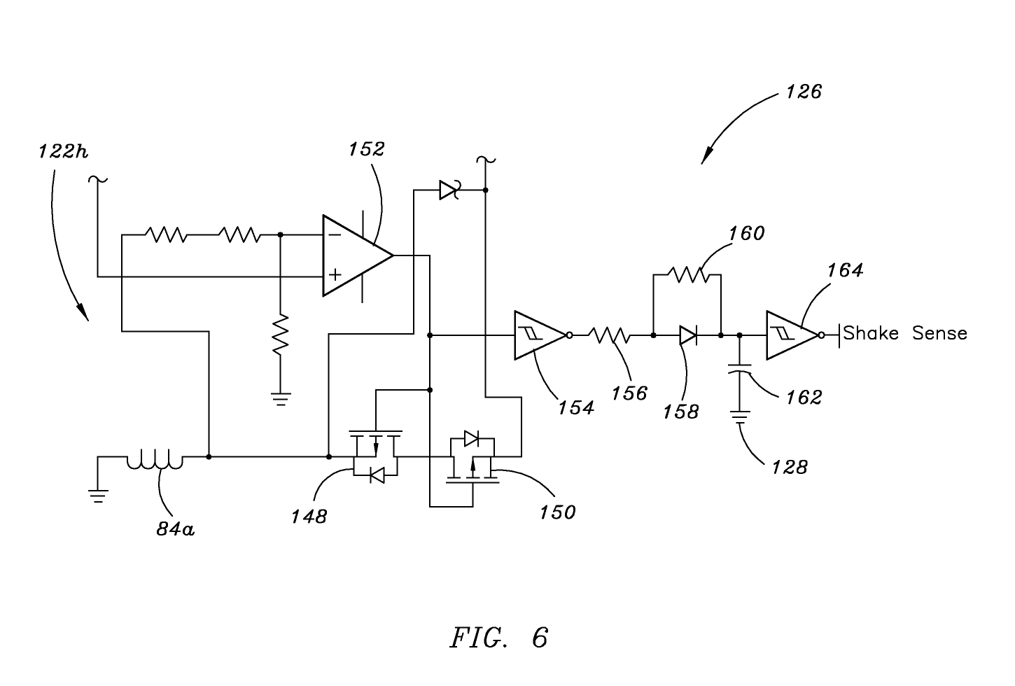

Referring now to FIG. 6, shake sensor circuit 126 is connected along with p-channel transistors 148 and 150 to the output of comparator 152 of rectifier circuit 122h. Rectifier circuit 122h has a substantially similar structure as rectifier circuit 122a, which is described in detail above, and functions in a substantially similar manner to rectifier circuit 122a. Thus, rectifier circuit 122h is not described in detail herein. Shake sensor circuit 126 is designed to assert a shake sense signal to a battery charger, which increases the rate at which the battery charger charges a battery, when the voltage across coil 84a (Vcoil8) divided by 3.42 (Vcoil8/3.42) exceeds the voltage of electric energy storage circuit 124 (Vgen) divided by 3.4 (Vgen/3.4). As shown in FIG. 2, coil 84a is positioned at the top of generator 10. Free magnet 16 will typically only reach coil 84a and induce current within coil 84a when generator 10 is being shaken. When a user is walking with generator 10 and not actively shaking generator 10, magnet 16 will typically not reach coil 84a and will not induce current within coil 84a. If a user is shaking generator 10, then the coils 62a, 64a, 66a, 68a, 70a, 72a, 74a, 76a, 78a, 80a, 82a, and 84a will typically generate more than ten times as much electric energy that is transferred to electric energy storage circuit 124 than if a user is walking with generator 10. When the generator 10 is being shaken and generating more electric energy, the shake sense signal sent to the battery charger instructs the charger to charge the battery at a faster rate.

Shake sensor circuit 126 includes a Schmitt trigger inverter 154 with an input that is connected to the output of comparator 152 and an output that is connected to one end of a resistor 156. The other end of resistor 156 is connected to the anode of a diode 158 and to one end of a resistor 160 that is connected in parallel with diode 158. The cathode of diode 158 and the other end of resistor 160 are connected to one side of a capacitor 162 and the input of another Schmitt trigger inverter 164. The other side of capacitor 162 is connected to ground 128. The output of Schmitt trigger inverter 164 asserts a shake sense signal, which controls the rate at which a battery charger operates, as discussed more fully below.

When Vcoil8/3.42 exceeds Vgen/3.4 and the output of comparator 152 switches to low, the input of Schmitt trigger inverter 154 is set to low and the output of Schmitt trigger inverter 154 is set to high. When the output of Schmitt trigger inverter 154 is set to high, capacitor 162 is quickly charged through resistor 156 and diode 158. Capacitor 162 is quickly charged to a voltage level that exceeds the positive threshold of Schmitt trigger inverter 164, which sets the output of Schmitt trigger inverter 164 to low. A low output of Schmitt trigger inverter 164 asserts the shake sense signal that is sent to the battery charger, and thereby instructs the battery charger to charge the battery at a higher rate when Vgen reaches a charging level as described below. When Vcoil8/3.42 no longer exceeds Vgen/3.4 and the output of comparator 152 switches to high, the output of Schmitt trigger inverter 154 is set to low. This causes capacitor 162 to slowly discharge through resistor 160. If Vcoil8/3.42 does not exceed Vgen/3.4 for a shake sense signal delay time, which is determined by the resistance of resistor 160 and capacitance of capacitor 162 and is most preferably approximately 0.24 seconds, capacitor 162 discharges through resistor 160 to a level that is low enough to drop below the positive threshold of Schmitt trigger inverter 164, which sets the output of Schmitt trigger inverter 164 high. This de-asserts the shake sense signal to the battery charger.

Resistor 156 preferably has a resistance of between approximately 0 to 1000 ohms, resistor 160 preferably has a resistance of approximately 2.4 megaohms, and capacitor 162 preferably has a capacitance of approximately 0.1 microfarad.

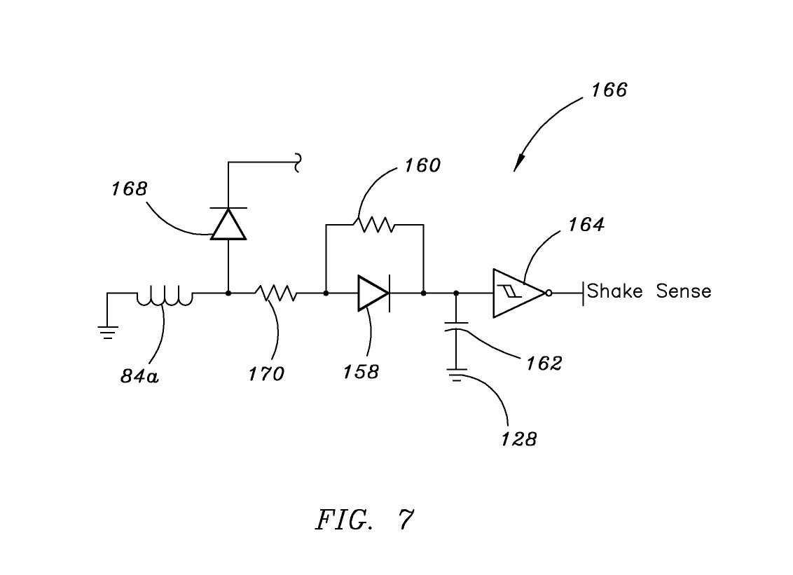

FIG. 7 shows an alternative embodiment of shake sensor circuit 166 for use with an alternative embodiment of rectifier circuit 122h that only includes a diode 168 and not the p-channel transistors 148 and 150 and comparator 152. A diode only rectifier circuit is described above as an alternative embodiment to any of rectifier circuits 122a-h. Shake sensor circuit 166 utilizes many of the same components of shake sensor circuit 126 shown in FIG. 6, including diode 158, resistor 160, capacitor 162, and Schmitt trigger inverter 164. Shake sensor circuit 166 also includes a resistor 170 with one end that is connected to the output of coil 84a and the other end connected to resistor 160 and diode 158. In this configuration, when current is induced in coil 84a, that current quickly charges capacitor 162 through resistor 170 and diode 158. This sets the output of Schmitt trigger inverter 164 to low which asserts the shake sense signal as discussed above. Capacitor 162 slowly discharges through resistors 160 and 170 back into coil 84a to de-assert the shake sense signal when current is not being induced in coil 84a. This sets the output of Schmitt trigger inverter 164 to high which de-asserts the shake sense signal. Resistor 170 preferably has a resistance of between approximately 0 to 1000 ohms.

FIG. 4B shows the components of both of the shake sensor circuits 126, shown in FIGS. 6, and 166, shown in FIG. 7. For the shake sensor circuit 126, the resistor 170 and another resistor 172 shown in FIG. 4B would not be installed. The purpose of resistor 172 is to ground the input of Schmitt trigger inverter 154 for the diode only shake sense circuit 166. The Schmitt trigger inverter 154 may still be present in an embodiment of generator 10 including shake sensor circuit 166, for example if it is present on a circuit board including other inverters that are being used in other areas of generator 10, but it is not functional for the diode only shake sensor circuit 166 because the signal from coil 84a passes through resistor 170 and diode 158 to capacitor 162. For the shake sensor circuit 166, the resistor 156 is not installed to disconnect the Schmitt trigger inverter 154 from the resistor 160.

The diodes 132 (FIG. 5) and 158 (FIG. 4B) used in the rectifier and energy storage circuit 120 are preferably Fairchild part number BAT54 diodes. The comparators 136 (FIG. 5) used in the rectifier and energy storage circuit 120 are preferably Microchip Technology part number MCP6544 comparators. The p-channel transistors, or MOSFETs, 134 and 140 used in the rectifier and energy storage circuit 120 are preferably Vishay Siliconix part number Si2305 CDS transistors.

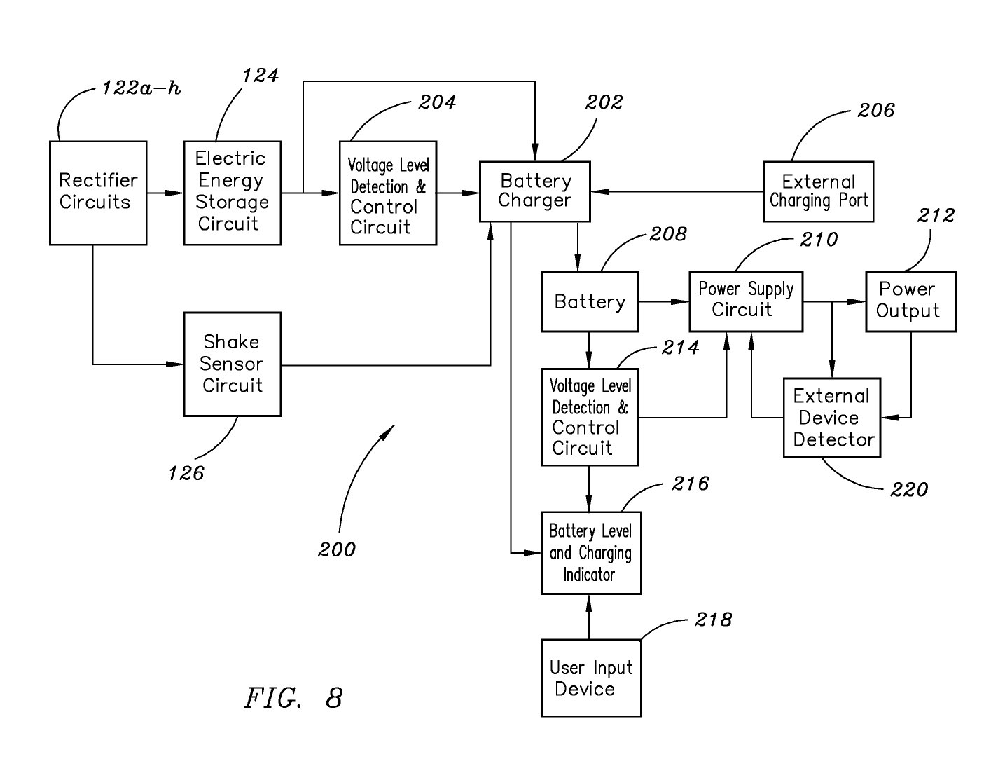

Referring to FIG. 8, a battery charging and power supply circuit is identified generally as 200. Battery charging and power supply circuit 200 is connected to the electric energy storage circuit 124 and shake sensor circuit 126 shown on FIG. 4B. Battery charging and power supply circuit 200 includes a battery charger 202 that is connected to electric energy storage circuit 124, and a first voltage level detection and control circuit 204 that is connected to both the electric energy storage circuit 124 and battery charger 202. Battery charger 202 is also connected to shake sensor circuit 126, an external charging port 206, and a battery 208. Battery 208 is connected to a power supply circuit 210 that is connected to a power output 212. A second voltage level detection and control circuit 214 is connected to the battery 208, power supply circuit 210, and power output 212. A battery level and charging indicator 216 is connected to the battery charger 202 and second voltage level detection and control circuit 214. A user input device 218 is connected to battery level and charging indicator 216. An external device detector is connected to power output 212 and power supply circuit 210.

Voltage level detection and control circuit 204 detects the voltage, Vgen, across the capacitors 142 and 144 (FIG. 4B) of electric energy storage circuit 124. When Vgen reaches a charging level, which is preferably between approximately 4.5 and 6V, and most preferably approximately 5.0V, voltage level detection and control circuit 204 sends a signal to battery charger 202 that instructs battery charger 202 to power on and charge battery 208 with electric energy received from electric energy storage circuit 124. Battery charger 202 charges battery 208 until Vgen drops below a charging shut-off level, which is preferably between approximately 2V to 0.1V less than the charging level, and most preferably approximately 4.5V. At that time, voltage level detection and control circuit 204 instructs battery charger 202 to turn off. Battery charger 202 also turns on to charge battery 208 when an external power source is connected to external charging port 206. External charging port 206 preferably includes the USB micro type B receptacle 44b shown in FIG. 3. The battery charger 202 is preferably operable to charge battery 208 at different charging currents depending on inputs from shake sensor circuit 126 and external charging port 206. Battery charger 202 charges battery 208 at a first, lower charging current when shake sensor circuit 126 is not asserting a shake sense signal to indicate that the generator 10 is being shaken, as described above, and when no external power source is connected to external charging port 206. When shake sense signal is asserted by shake sensor circuit 126 or an external power source is connected to external charging port 206, battery charger 202 charges battery 208 at a second, higher charging current. The first charging current is preferably approximately 85 milliamps, and the second charging current is preferably approximately 450 milliamps.

Second voltage level detection and control circuit 214 detects the voltage of battery 208, Vbatt, and external device detector 220 detects when an external device is connected to power output 212. Voltage level detection and control circuit 214 sends a signal to power supply circuit 210 that turns on power supply circuit 210 when Vbatt reaches an enable power supply level, which is preferably approximately 3.15V, and an external device is connected to power output 212. When it turns on, power supply circuit 210 draws energy stored within battery 208 to supply power at 5V and 1A to the external device connected to power output 212. External device detector 220 senses that an external device is connected to power output 212 by either detecting that the shield of a USB plug on the external device is grounded, or detecting that power output 212 is drawing current from battery 208. Power output 212 preferably includes the USB type A receptacle 44a shown in FIG. 3.

In addition to the enable power supply voltage level, second voltage level detection and control circuit 214 is configured to detect when Vbatt reaches five voltage levels, which are preferably 3.36V, 3.58V, 3.69V, 3.78V, and 3.92V. When a user activates user input device 218, battery level and charging indicator 216 displays to the user which of the five voltage levels Vbatt meets or exceeds. User input device 218 preferably includes button 36 shown in FIG. 3, and battery level and charging indicator 216 preferably includes the five LED lights 34 shown in FIG. 3. The five LED lights 34 correspond to the five voltage levels detected by voltage level detection and control circuit 214. Thus, when user presses button 36, the LED lights 34 turn on to indicate to the user which of the five voltage levels have been met or exceeded by Vbatt. For example, if Vbatt is at 3.7V, the first three LED lights 34, which are the first three lights on the left as shown in FIG. 3, light up when button 36 is pressed because Vbatt meets or exceeds the first three voltage levels, 3.36V, 3.58V, and 3.69V. If Vbatt is 4V, all five of the LED lights 34 light up when button 36 is pressed. Preferably, when button 36 is pressed the LED lights 34 turn on in succession. For example, if three LED lights 34 turn on when button 36 is pressed, there is a brief time delay of preferably approximately 0.2 seconds after the first LED light 34 turns on before the second LED light 34 turns on, and another similar brief time delay after the second LED light 34 turns on before the third LED light 34 turns on. The fifth LED light 34, which is the rightmost LED light 34 as viewed in FIG. 3, also turns on when battery charger 202 is powered on to indicate to the user that battery 208 is being charged.

Battery charger 202 is preferably a MCP73811 single cell lithium-ion battery charger. Battery 208 is preferably a lithium-ion or lithium polymer batter with a nominal specified voltage of between approximately 3.6 to 3.8V. A few suitable types of batteries for battery 208 include a 2400-4000 mAh or higher 18650 lithium ion battery, a 1600 mAh 18500 lithium-ion battery, or a customized lithium polymer cell of up to 5000 mAh or more. First and second voltage level detection and control circuits 204 and 214 preferably utilize resistor voltage dividers and comparators to detect when Vgen and Vbatt reach certain voltage levels, and include appropriate logic circuit components to send appropriate signals to battery charger 202, power supply circuit 210, and battery level and charging indicator 216 to perform the functions described above. Alternatively, these circuits 204 and 214 may comprise a microcontroller programmed with software to perform the functions identified above. Power supply circuit 210 is preferably a LT1308 1A 5V power supply circuit or any suitable high efficiency step-up DC to DC voltage converter.

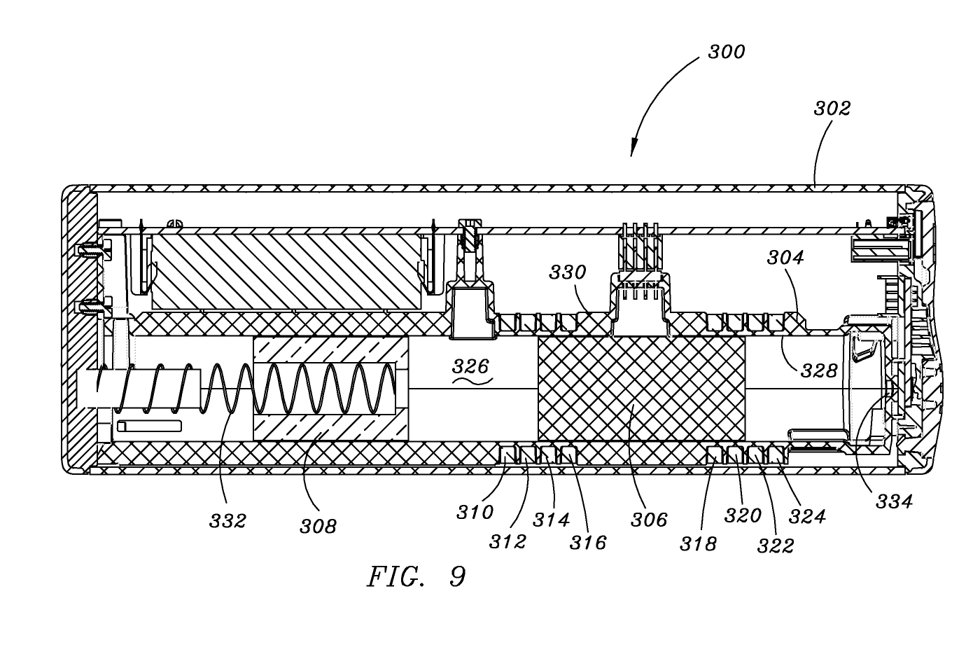

Referring to FIG. 9, an alternative embodiment of linear generator is shown generally as 300. Linear generator 300 is similar to linear generator 10 described above. Accordingly, only the differences between linear generator 10 and linear generator 300 are described in detail herein. Linear generator 300 includes a housing 302 within which is positioned a coil array mount 304, free magnet 306, sprung magnet 308, and eight magnet wire coils 310, 312, 314, 316, 318, 320, 322, and 324. Coil array mount 304 defines a cylindrical void 326 within which free magnet 306 and sprung magnet 308 are positioned. Free magnet 306 and sprung magnet 308 are cylindrical and guided by an inner wall 328 of coil array mount 304 as the free magnet 306 and sprung magnet 308 oscillate within the coil array mount 304 in a similar manner as described above with respect to generator 10.

Each of the magnet wire coils 310, 312, 314, 316, 318, 320, 322, and 324 is positioned within an annular recess formed in an outer surface 330 of coil array mount 304. Each of the coils 310, 312, 314, 316, 318, 320, 322, and 324 has approximately 180 turns of 30 gauge magnet wire. The dimensions of coils 310, 312, 314, 316, 318, 320, 322, and 324 may be within the ranges set forth above for generator 10. Sprung magnet 308 has an outer cylindrical surface and a recess that receives a portion of a spring 332. The spring 332 extends between a portion of housing 302 and sprung magnet 308. Sprung magnet 308 and free magnet 306 are positioned to repel eachother. Spring 332 and magnets 306 and 308 are configured so that when the generator 300 is vertical and the magnets 306 and 308 are in an equilibrium position, the bottom of free magnet 306 is positioned just above the top of coil 312 and the top of free magnet 306 is positioned just above the top of coil 320, as shown in FIG. 9. When the magnets 306 and 308 are in this equilibrium position, the spring 332 is approximately half-way compressed. The spring 332 is a compression spring made of bronze, brass, stainless steel, or other suitable metal with low or zero magnet permeability. A fixed magnet 334 is positioned at the top of the housing 302 for similar purposes as magnet 103 of generator 10.

Coils 310, 312, 314, and 316 are wound to the right, and coils 318, 320, 322, and 324 are wound to the left. Coils 310 and 318 are connected in series, coils 312 and 320 are connected in series, coils 314 and 322 are connected in series, and coils 316 and 324 are connected in series. Coils 310 and 318 are spaced at exactly the height of free magnet 306 so that as the ends of the magnet 306 move through the coils 310 and 318, electric energy simultaneously induced within the coils 310 and 318 by the magnet 306 is substantially in phase in the same manner as discussed above with respect to generator 10. Coils 312 and 320, coils 314 and 322, and coils 316 and 324 are also spaced the height of free magnet 306. The coils 310, 312, 314, 316, 318, 320, 322, and 324 may be spaced from each other distances that are within the ranges set forth above for generator 10. Further, the height of the magnet 306 relative to the coils 310, 312, 314, 316, 318, 320, 322, and 324 may be within the ranges set forth above with respect to generator 10 such that the magnet 306 preferably spans several of the coils for greater efficiency.

The magnets 306 and 308 preferably have masses and oscillate at frequencies within the ranges specified above for the magnets of generator 10. Generator 300 preferably generates between 0.06 and 0.07 watts (13.5 mA to 19 mA at 3.7V) when a person walks with it.

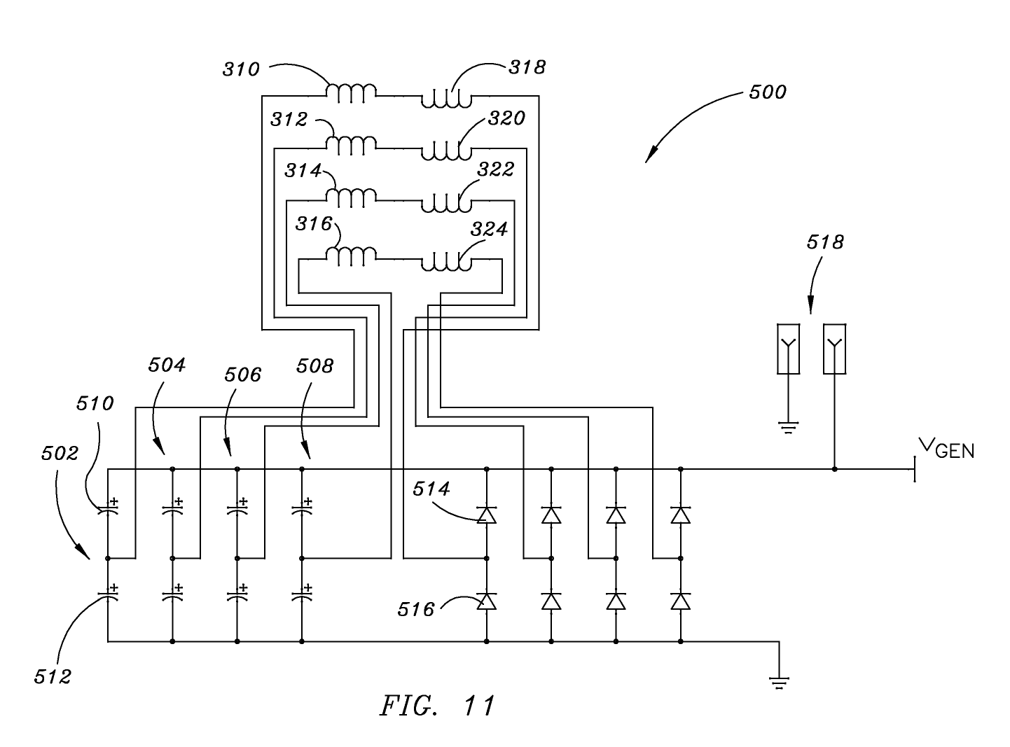

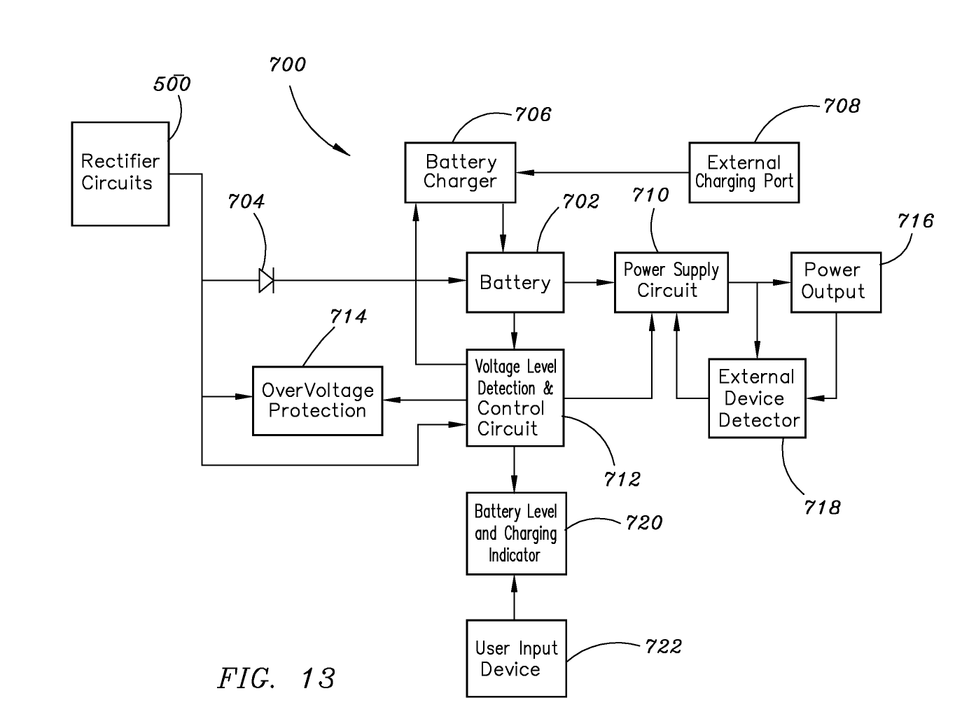

Generator 300 preferably includes on a circuit board the rectifier circuit 500 shown in FIG. 11 and the battery charging and power supply circuit 700 shown in FIG. 13; however, it is within the scope of the invention for generator 300 to use a rectifier and energy storage circuit similar to the rectifier circuit 120 shown in FIGS. 4A and 4B and a battery charging and power supply circuit similar to the battery charging and power supply circuit 200 shown in FIG. 8.

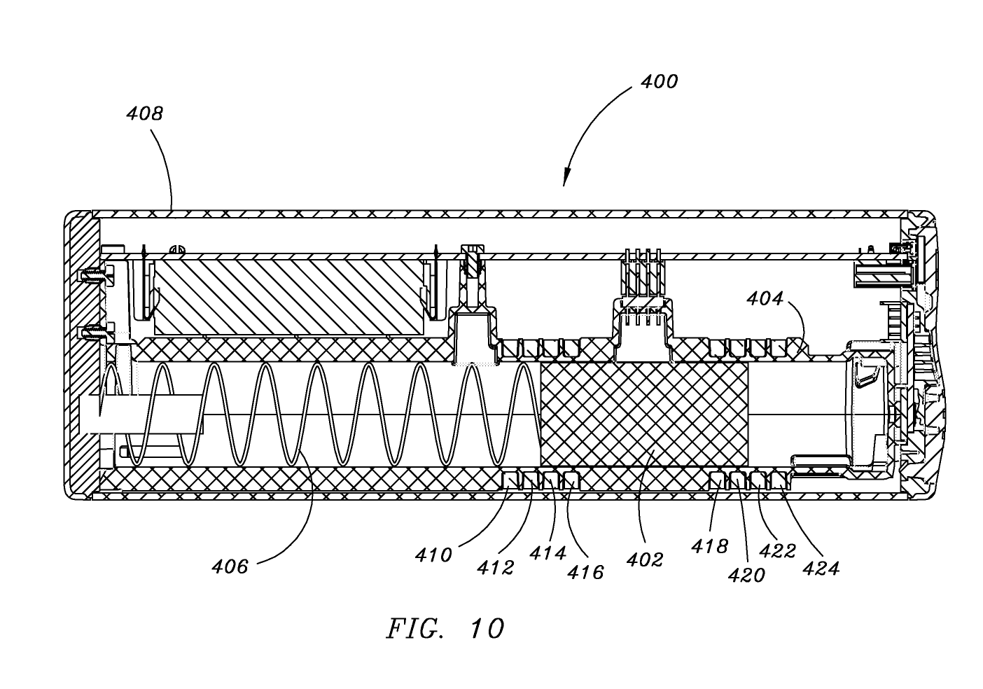

Another alternative embodiment of linear generator in accordance with the present invention is shown generally as 400 in FIG. 10. Linear generator 400 is substantially similar to linear generators 10 and 300. Accordingly, only the differences between generators 10 and 300 and generator 400 are described in detail herein. Unlike linear generator 300, which includes a sprung magnet 308, linear generator 400 only includes a free magnet 402 that oscillates within a coil array mount 404. A spring 406 extends between the free magnet 402 and a portion of a housing 408. The generator 400 includes eight magnet wire coils 410, 412, 414, 416, 418, 420, 422, and 424. The magnet 402 and spring 406 are configured so that when the generator 400 is vertical and the magnet 402 is in an equilibrium position, the bottom of free magnet 402 is positioned just above the top of coil 412 and the top of free magnet 402 is positioned just above the top of coil 420, as shown in FIG. 10. When the magnet 402 is in this equilibrium position, the spring 406 is approximately half-way compressed. The spring 406 is a compression spring made of bronze, brass, stainless steel, or other suitable metal with low or zero magnet permeability. Generator 400 otherwise operates in a similar manner and has similar features, specifications, and components as generators 10 and 300 described above.

Referring now to FIG. 11, a rectifier circuit is shown generally as 500. Rectifier circuit 500 is preferably contained on a circuit board within generators 300 and 400 in a similar manner as described above with respect to the circuitry of generator 10. For purposes of the below description of rectifier circuit 500, the magnet wire coils within the rectifier circuit 500 will be identified as the coils 310, 312, 314, 316, 318, 320, 322, and 324 of generator 300.

Rectifier circuit 500 includes four voltage doubling full-wave bridge rectifiers 502, 504, 506, and 508 that are connected in parallel. Rectifier 502 includes coils 310 and 318, which are connected in series. Rectifier 504 includes coils 312 and 320, which are connected in series. Rectifier 506 includes coils 314 and 322, which are connected in series. Rectifier 508 includes coils 316 and 324, which are connected in series. Each of rectifiers 502, 504, 506, and 508 is substantially similar; accordingly, only rectifier 502 is described in detail herein. It is within the scope of the invention for rectifier 502 to be substituted for any of the rectifiers 122a-h described above and shown in FIGS. 4A and 4B.

For rectifier 502, one end of coil 310 is connected to coil 318 and the other end of coil 310 is connected between first and second capacitors 510 and 512. One end of coil 318 is connected to an end of coil 310 and the other end is connected between first and second diodes 514 and 516. Capacitors 510 and 512 are connected together in series. One end of capacitor 510 is connected to the anode of diode 514. The voltage at this end of capacitor 510 represents the voltage, Vgen, which is the voltage captured by the rectifier circuit 500 and delivered to battery 702, as described below in connection with FIG. 13. The other end of capacitor 510 is connected to coil 310 and an end of capacitor 512. The other end of capacitor 512 is connected to the cathode of diode 516 and to ground. Diodes 514 and 516 are connected in series. The cathode of diode 514 is connected to coil 318 and the anode of diode 516.

As one pole of magnet 306 approaches coil 310 while the other pole of magnet 306 simultaneously approaches coil 318, the voltage at the anode of diode 514 increases. When this voltage exceeds Vgen by more than the diode drop of diode 514, current flows through diode 514 and charges capacitor 510. When the poles of the magnet 306 approach the respective centers of coils 310 and 318, the voltage at the anode of diode 514 no longer exceeds Vgen by more than the diode drop of diode 514 and current stops flowing through diode 514. Diode 514 prevents capacitor 510 from discharging except into Vgen, or battery 702.

As the poles of the magnet 306 begin to recede from the respective centers of the coils 310 and 318, the voltage on the cathode of diode 516 drops. When this voltage is lower than ground by more than the diode drop of diode 516, current flows through diode 516 and charges capacitor 512. When the poles of the magnet 306 recede from coils 310 and 318 or when the magnet 306 slows, the voltage across diode 516 will no longer exceed the diode drop of diode 516 and current stops flowing through diode 516. Diode 516 prevents capacitor 512 from discharging except into capacitor 510.

Rectifier 502 doubles the voltage generated because the charges on capacitors 510 and 512 are added together to more easily generate a voltage that is higher than that already stored by the generator 300, thereby adding to the stored energy. This configuration is superior to a conventional full-wave diode bridge rectifier because of the voltage doubling feature. Applicant has found that rectifier 502 produces between 30% and 50% more power than a full-wave diode bridge topology in this particular application. The higher performance is likely due both to reduction of diode voltage drop losses, their being two diodes in rectifier 502 instead of the four that are in a full-wave diode bridge rectifier, and because of the voltage doubling function. FIG. 11 also shows an optional external charging source 518 connected to Vgen, which may be any type of USB input.

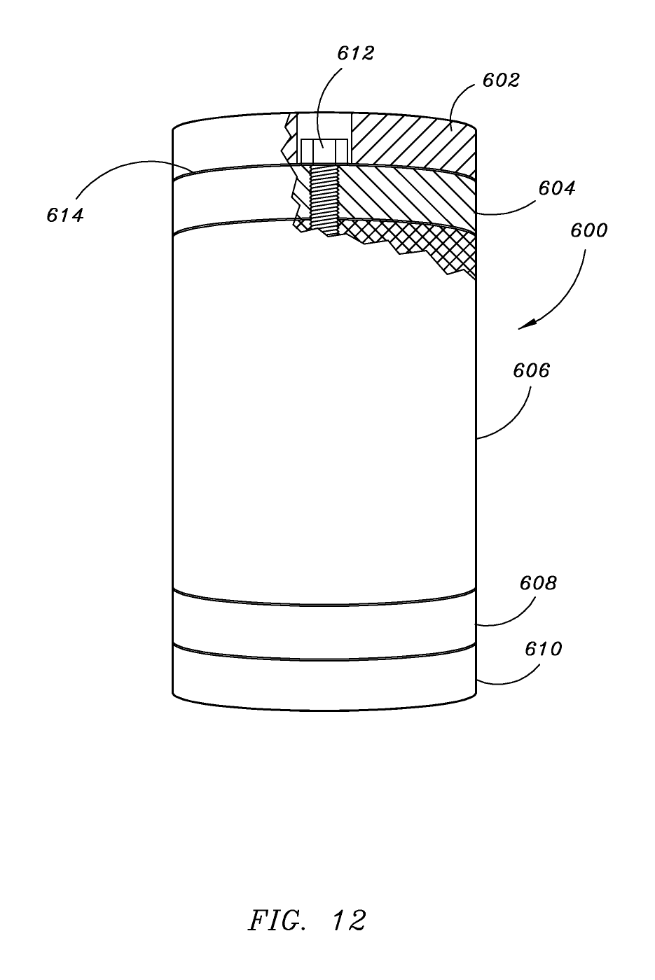

A magnet assembly is shown generally as 600 in FIG. 12. Magnet assembly 600 may be used in place of magnets 306 and 402 described above. Magnet assembly 600 could also be substituted for magnet 16 in generator 10 if the generator 10 was modified to not include rod 30. Magnet assembly 600 includes a first magnet 602, second magnet 604, third magnet 606, fourth magnet 608, and fifth magnet 610. When magnet assembly 600 is used in generator 10, magnet 606 has a height that is equal to the height of free magnet 16, shown in FIG. 2, so that the height of magnet 606 is equal to the space between two series connected coils of the generator 10. Likewise, when magnet assembly 600 is used in generator 300 (FIG. 9), magnet 600 has a height that is equal to the height of magnet 306, and when magnet assembly 600 is used in generator 400 (FIG. 10), magnet 600 has a height that is equal to the height of magnet 402. Each of the magnets 602, 604, 606, 608, and 610 has a hole through its center. The hole through magnets 602 and 610 is slightly larger than the hole in magnets 604, 606, and 608. A bolt 612 passes through the holes in magnets 602, 604, 606, 608, and 610. The head of bolt 612 is positioned within the hole through magnet 602 and abuts an upper surface of magnet 604. A nut (not shown) is threaded on bolt 612 and resides within the hole of magnet 610. The nut abuts a lower surface of magnet 608 and is tightened to secure the magnets 604, 606, and 608 together. A non-magnetically permeable spacer, one of which is identified as 614, having a thickness of approximately 0.2 mm is positioned between each pair of adjacent magnets 602, 604, 606, 608, and 610.

First magnet 602 is positioned so that it is attracted to second magnet 604. Second magnet 604 repels third magnet 606. Third magnet 606 repels fourth magnet 608. Fourth magnet 608 is attracted to fifth magnet 610.

Magnet assembly 600 when substituted for either of magnets 306 and 402 preferably improves the performance of generators 300 and 400 by approximately 40%. Generator 300 preferably generates about 20 mA average at 3.7V when a person walks with it. Substituting magnet assembly 600 for magnet 306 preferably increases the performance of generator 300 to about 28 mA average at 3.7V. Magnets 306, 402, 602, 604, 606, 608, and 610 are preferably N48 grade neodymium magnets or higher.

FIG. 13 shows a battery charging and power supply circuit 700 preferably used in generators 300 and 400. Battery charging and power supply circuit 700 may also be used in generator 10 as a substitute for battery charging and power supply circuit 200. Circuit 700 includes a battery 702 that is connected to Vgen of rectifier circuit 500 through a diode 704, which prevents the battery 702 from discharging into the rectifier circuit 500. Battery 702 is also connected to a battery charger 706, which is connected to an external charging port 708. External charging port 708 may include a USB micro type B receptacle such as receptacle 44b shown in FIG. 3. Battery charger 706 is preferably controlled to charge at 500 mA. Battery 702 is preferably a single lithium-ion or lithium polymer battery with a nominal voltage of 3.6 to 3.8 volts. A suitable battery would be a 2400 to 3400 mAhr 18650 cell.

Battery 702 is connected to a power supply 710, which is preferably a TPS55330 1A 4-6V power supply. The power supply 710 is connected to a voltage level detection and control circuit 712, which is connected to battery 702, rectifier circuit 500, and battery charger 706. An overvoltage protection circuit 714 is connected to rectifier circuit 500 and voltage level detection and control circuit 712. Power supply 710 is connected to a power output 716, which may include the USB type A receptacle 44a shown in FIG. 3. An external device detector 718 is connected to power output 716 and power supply circuit 710.

Voltage level detection and control circuit 712 senses the voltage on battery 702. Power supply 710 is turned on when the voltage on battery 702 is above a certain level, preferably about 2.94V, and external device detector 718 detects a device connected to power output 716. External device detector 718 detects the presence of a device connected to power output 716 either by sensing that power output 716 is drawings current from battery 702 or that the shield of a USB plug on the external device is grounded. Power supply 710 has a nominal output level of 5V, but can be set to 4.77V to optimize power conversion efficiency to external devices being charged. Power supply 710 powers a device connected to output 716 and any logic internal to the system circuitry 700. Power supply 710, power output 716, and external device detector 718 may operate in a similar manner as described above for circuit 200 in FIG. 8.

A battery level and charging indicator 720 is connected to voltage level detection and control circuit 712 and a user input device 722 is connected to battery level and charging indicator 720. These preferably function as described above with respect to battery level and charging indicator 216 and user input device 218 in FIG. 8.

Overvoltage protection 714 senses when the battery 702 is at full charge, preferably about 4.16V, and dumps any current attempting to enter battery 702 into resistors to prevent overcharging of the battery.

In operation, any of generators 10, 300 and 400 may be carried by a person while they are walking, hiking, running, or moving in any manner. The generators 10, 300 and 400 are designed to be carried so that they are upright, or nearly so, in the orientation shown in FIG. 2 so that button 36 is on the top of generator 10. The generators 10, 300 and 400 may be placed in or attached to a backpack, bag, purse, or pocket in this vertical orientation. The generators 10, 300 and 400 may also be placed on or mounted to an object that moves linearly so that the longitudinal axis of one of the generators 10, 300 and 400 is aligned with the linear movement of the object. Examples of linear moving objects to which generators 10, 300 and 400 may be mounted include bicycle frames or shock absorbers, motorcycle or automobile frames or shock absorbers, wind or fuel powered watercraft, or any other mobile device that experiences movement with a linear motion and is associated with the use of battery powered devices.

With respect to generator 10, as the person walks, hikes, or runs, or the object moves, the free magnet 16 (FIG. 2) moves through the coils 62a, 64a, 66a, 68a, 70a, 72a, 74a, 76a, 78a, 80a, 82a, and 84a in the manner described in detail above to induce electric current in those coils. To accelerate charging of battery 208, the user may shake generator 10 thereby moving magnet 16 through coils 62a, 64a, 66a, 68a, 70a, 72a, 74a, 76a, 78a, 80a, 82a, and 84a more rapidly and activating the shake sensor circuit 126 in the manner described above. Rectifier circuits 122a-h, which contain the coils 62a, 64a, 66a, 68a, 70a, 72a, 74a, 76a, 78a, 80a, 82a, and 84a, charge electric energy storage circuit 124, which supplies energy to battery charger 202 for charging battery 208. When battery 208 is charged to an enable power supply level and an external device is connected to USB port 44a (FIG. 3) of power output 212 (FIG. 8), power supply circuit 210 supplies power from battery 208 to the external device. The user may also charge the battery 208 of generator 10 by connecting an external source of power to the USB port 44b (FIG. 3) of external charging port 206 (FIG. 8). The user may press the button 36 (FIG. 3) of user input device 218 (FIG. 8) in order to receive a visual indication of the charging level of battery 208 via LED lights 34 (FIG. 3). Generators 300 and 400 operate in a similar manner except with respect to any differences noted above.

A linear generator comprising, a coil comprising an opening, a magnet that moves through the opening in the coil to induce electric current in the coil, an electric energy storage device electrically coupled with the coil, and a battery charger electrically coupled with the electric energy storage device, wherein the battery charger receives electric energy from the electric energy storage device when the electric energy stored in the electric energy storage device reaches a charging level.

The linear generator described above, wherein the battery charger charges a battery at a maximum electric current level, and wherein the electric energy storage device is operable to store the electric energy from an electric current that is greater than the maximum electric current level of the battery charger.

The linear generator described above, wherein the electric energy storage device is a capacitor.

A linear generator comprising, a coil comprising an opening, a magnet that moves through the opening in the coil to induce electric current in the coil, a rectifier electrically coupled to the coil, and an electric energy storage device electrically coupled with the rectifier, wherein the electric energy storage device receives electric energy from the coil through the rectifier when a level of voltage in the coil is greater than a level of voltage in the electric energy storage device.

The linear generator described above further comprising a second coil comprising an opening, wherein the magnet moves through the opening in the second coil to induce electric current in the second coil, a second rectifier electrically coupled to the second coil, wherein the rectifier and second rectifier are electrically coupled in parallel and the second rectifier is electrically coupled with the electric energy storage device, wherein the electric energy storage device receives electric energy from the second coil through the second rectifier when a level of voltage in the second coil is greater than the level of voltage in the electric energy storage device.

The linear generator described above wherein the rectifier comprises a diode.

The linear generator described above wherein the rectifier comprises a comparator electrically coupled with the coil and the electric energy storage device, and a switch electrically coupled with the comparator, coil, and electric energy storage device, wherein the switch has an on position, in which the electric energy storage device is electrically coupled with the coil, and an off position, in which the electric energy storage device is not electrically coupled with the coil, wherein the comparator sends an electric signal to the switch that places the switch in the on position when the level of voltage in the coil is greater than the level of voltage in the electric energy storage device.

The linear generator described above, wherein the switch comprises first and second p-channel transistors each comprising a gate, a source and a drain, wherein the gate of each of the first and second p-channel transistors is electrically coupled with the comparator to receive the electric signal from the comparator, wherein the source of the first p-channel transistor is electrically coupled with the coil, wherein the drains of the first and second p-channel transistors are electrically coupled, and wherein the source of the second p-channel transistor is electrically coupled with the electric energy storage device.

The linear generator described above, wherein the rectifier comprises a diode that is electrically coupled with the coil and the electric energy storage device.

A rectifier operable to be electrically coupled between an electric energy source and an electric energy storage device, comprising, a first voltage divider electrically coupled with the electric energy source, a second voltage divider electrically coupled with the electric energy storage device, a comparator with a first input that is electrically coupled with the first voltage divider and a second input that is electrically coupled with the second voltage divider, a first p-channel transistor with a gate that is electrically coupled with an output of the comparator, a source that is electrically coupled with the electric energy source, and a drain, and a second p-channel transistor with a gate that is electrically coupled with the output of the comparator, a source that is electrically coupled with the electric energy storage device, and a drain that is electrically coupled with the drain of the first p-channel transistor.

The rectifier described above, further comprising a diode that is electrically coupled with the electric energy source and the electric energy storage device.

The rectifier described above, wherein, when a level of voltage in the electric energy source is greater than a level of voltage in the electric energy storage device, the comparator sends an electric signal to the gates of the first and second p-channel transistors that electrically connects the source and the drain of each of the first and second p-channel transistors to electrically connect the electric energy source and electric energy storage device.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A linear generator comprising:
a plurality of coils each having an opening that is aligned with the opening of the other coils, wherein adjacent coils are spaced apart no more than approximately 6 millimeters; and
a magnet that moves through the opening of each of the coils, wherein the magnet has a height that is greater than a combined height of at least two of the coils.

2. The linear generator of claim 1, wherein the plurality of coils comprises at least four coils, and wherein the magnet has a height that is greater than a combined height of the at least four coils.

3. The linear generator of claim 1, wherein adjacent coils are spaced apart no more than approximately 4 millimeters.

4. The linear generator of claim 1, wherein adjacent coils are spaced apart between approximately 1 to 3 millimeters.

5. The linear generator of claim 1, further comprising a housing to which the coils are coupled, wherein the housing guides movement of the magnet through the opening of each of the coils.

6. The linear generator of claim 5, wherein the housing comprises a rod that is received by the opening of each of the coils, and wherein the magnet comprises an opening that receives said rod for guiding movement of the magnet.

7. The linear generator of claim 6, wherein the rod comprises a low friction, diamagnetic surface comprising pyrolytic graphite.

8. The linear generator of claim 1, wherein the magnet comprises a first magnet and further comprising a second magnet that moves in a direction that is aligned with the direction of movement of the first magnet, wherein the second magnet is oriented to repel the first magnet, and wherein the second magnet may move at a slower speed than the first magnet.

9. The linear generator of claim 8, wherein the first magnet reciprocates at a frequency of between approximately 2 to 15 Hertz, and wherein the second magnet reciprocates at a frequency of between approximately 1.5 to 2.5 Hertz when the magnets move vertically and the coils and magnets are being carried by an adult human that is walking.

10. The linear generator of claim 8, further comprising a magnet assembly comprising the second magnet, wherein the magnet assembly has a mass that is greater than the mass of the first magnet.

11. The linear generator of claim 10, wherein the mass of the magnet assembly is between approximately 0.5 to 4 times the mass of the first magnet.

12. The linear generator of claim 11, wherein the mass of the magnet assembly is approximately 3 times the mass of the first magnet.

13. The linear generator of claim 1, wherein the plurality of coils includes at least one pair of coils with centers that are spaced apart the height of the magnet, wherein the coils of the pair of coils are connected in series such that current induced in one coil of the pair of coils as a result of movement of the magnet is substantially in phase with current induced in the other coil of the pair of coils as a result of movement of the magnet.

14. The linear generator of claim 13, wherein the coils of the pair of coils are wound in opposite directions.

15. A linear generator comprising:
a plurality of coils each having an opening that is aligned with the opening of the other coils, wherein adjacent coils are spaced apart no more than approximately 6 millimeters, wherein the plurality of coils includes at least one pair of coils with centers that are spaced apart a distance A, and wherein the coils of the pair of coils are connected in series; and
a magnet that moves through the opening of each of the coils, wherein the magnet has a height that is substantially equal to the distance A, wherein the height of the magnet is greater than a combined height of at least two of the coils, and wherein current induced in one coil of the pair of coils as a result of movement of the magnet is substantially in phase with current induced in the other coil of the pair of coils as a result of movement of the magnet.

16. The linear generator of claim 15, wherein the coils of the pair of coils are wound in opposite directions.

17. The linear generator of claim 15, wherein the plurality of coils comprises at least four coils, and wherein the magnet has a height that is greater than a combined height of the at least four coils.

18. The linear generator of claim 15, wherein adjacent coils are spaced apart no more than approximately 4 millimeters.

19. The linear generator of claim 15, wherein adjacent coils are spaced apart between approximately 1 to 3 millimeters.

20. The linear generator of claim 15, wherein the magnet comprises a first magnet and further comprising a second magnet that moves in a direction that is aligned with the direction of movement of the first magnet, wherein the second magnet is oriented to repel the first magnet, and wherein the second magnet moves at a slower speed than the first magnet.

21. The linear generator of claim 20, wherein the first magnet reciprocates at a frequency of between approximately 2 to 15 Hertz, and wherein the second magnet reciprocates at a frequency of between approximately 1.5 to 2.5 Hertz when the magnets move vertically and the coils and magnets are being carried by an adult human that is walking.

22. The linear generator of claim 20, further comprising a magnet assembly comprising the second magnet, wherein the magnet assembly has a mass that is greater than the mass of the first magnet.

23. The linear generator of claim 22, wherein the mass of the magnet assembly is between approximately 2 to 4 times the mass of the first magnet.

24. The linear generator of claim 23, wherein the mass of the magnet assembly is approximately 3 times the mass of the first magnet.

25. A linear generator comprising:
a plurality of coils each having an opening that is aligned with the opening of the other coils;
a first magnet that moves through the opening of each of the coils; and
a second magnet that moves in a direction that is aligned with the direction of movement of the first magnet, wherein the second magnet is oriented to repel the first magnet, and wherein the second magnet moves at a slower speed than the first magnet.

26. The linear generator of claim 25, wherein the first magnet reciprocates at a frequency of between approximately 2 to 15 Hertz, and wherein the second magnet reciprocates at a frequency of between approximately 1.5 to 2.5 Hertz when the magnets move vertically and the coils and magnets are being carried by an adult human that is walking.

27. The linear generator of claim 25, further comprising a magnet assembly comprising the second magnet, wherein the magnet assembly has a mass that is greater than the mass of the first magnet.

28. The linear generator of claim 27, wherein the mass of the magnet assembly is between approximately 2 to 4 times the mass of the first magnet.

29. The linear generator of claim 28, wherein the mass of the magnet assembly is approximately 3 times the mass of the first magnet.
